(19) United States
(12) Patent Application Publication
(10) Pub. No.: US 2009/0238889 A1
(43) Pub. Date: Sep. 24, 2009

(54) Hyper-Branched Polymers for the Provision of Hygienic Characteristics

(75) Inventors: Mirko Weide, Duesseldorf (DE); Steve Doering, Mettmann (DE); Roland Breves, Mettmann (DE); Anja Schloesser, Neuss (DE); Joerg Tiller, Dortmund (DE); Andreas Fuchs, Voerstetten (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/406,243

(22) Filed: Mar. 18, 2009

Related U.S. Application Data
(63) Continuation of application No. PCT/EP2007/060133, filed on Sep. 25, 2007.

(30) Foreign Application Priority Data
Sep. 27, 2006 (DE) 10 2006 046 073.1

(51) Int. Cl. A01N 25/26; A01P 1/00

(52) U.S. Cl. 424/497

(57) ABSTRACT

The invention relates to hyper-branched polymers having a hydrophobic core and an antimicrobial and/or anti-adhesive active shell for providing surfaces with semi-permanent hygienic characteristics.

### CROSS-REFERENCE TO RELATED APPLICATIONS

This application is a continuation under 35 U.S.C. §§ 120 and 365(c) of International Application PCT/EP2007/060133, filed on Sep. 25, 2007. This application also claims priority under 35 U.S.C. § 119 of DE 10 2006 046 073.1, filed on Sep. 27, 2006. The disclosures of PCT/EP2007/060133 and DE 10 2006 046 073.1 are incorporated herein by reference in their entirety for all purposes.

### BACKGROUND OF THE INVENTION

The present invention relates to hyper-branched polymers having a hydrophobic core and an antimicrobial and/or anti-adhesive active shell for providing surfaces with semi-permanent hygienic characteristics.

On hygienic grounds, cleaning agents are often furnished with antimicrobial additives. In this regard the antimicrobial action is generally limited over time, because the antimicrobially active additive, together with the cleaning agent, is washed off the treated surface again. However, it is desirable to afford a more long-lasting antimicrobial effect to the treated surface.

A possible contribution to solve this problem could consist in permanently equipping the surfaces with covalently bonded antimicrobial substances. This type of permanent finishing, however, is generally, if at all, then very difficult to carry out.

### SUMMARY OF THE INVENTION

Accordingly, the object of the present invention was to provide substances that allow a longer-lasting or semi-permanent provision of hygienic characteristics to surfaces, without the need for them to be covalently fixed on the surfaces in question.

Ideally, these substances should, moreover, be able to be incorporated into conventional laundry detergents and cleaning agents, such that semi-permanent hygienic characteristics can be achieved for surfaces that have been subjected to standard cleaning.

It has now been surprisingly found that hyper-branched block copolymers that have both a hydrophobic core and possess antimicrobially active groups, especially quaternary ammonium groups, are quite exceptionally suitable for achieving this object.

### DETAILED DESCRIPTION OF THE DRAWING

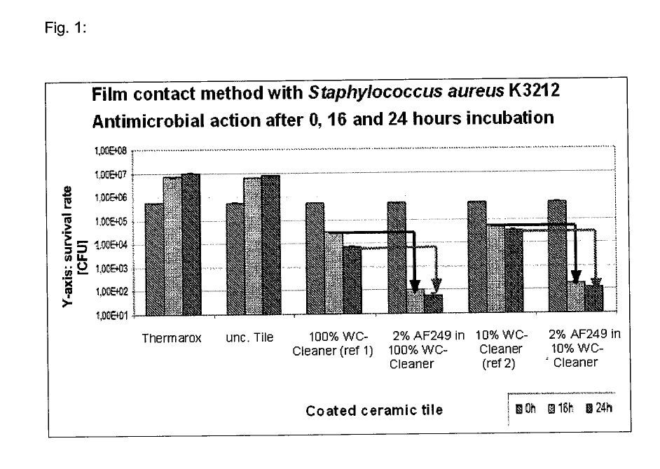

FIG. 1 shows the results obtained in certain antimicrobial tests using a particular hyper-branched polymer in accordance with the invention, as explained in more detail in the Examples.

### DETAILED DESCRIPTION OF THE INVENTION

The preparation of hyper-branched block copolymers from diisopropenylbenzene and additional monomers, e.g., vinylpyridine, is already known from the prior art (Polymer (2003) 44(8), 2213-2220; Macromolecular Chemistry and Physics (2001) 202(9), 1569-1575; WO04/113418). However, the preparation of antimicrobially active hyper-branched block copolymers has not been described in any of these publications.

Compositions, which comprise a mixture of quaternary ammonium compounds and dendritic polymers, are described in WO 03/024217; however no dendritic polymers are described that themselves would include quaternary ammonium compounds.

Moreover, it is also already known that dendritic polymers can be provided with antimicrobial characteristics (WO98/26662, U.S. Pat. No. 6,440,405; WO01/012725).

Dendrimers are described in WO98126662, which are modified with oligosaccharides to confer antimicrobial properties. Dendrimers containing quaternary ammonium groups are described in U.S. Pat. No. 6,440,405. However, the dendrimers described in these published patent documents do not possess the inventively advantageous hydrophobic regions that make possible the inventive semi-permanent attachment and thereby a longer-lasting antimicrobial effect.

Crosslinkable antimicrobial hyper-branched polymer compositions are described in WO 01/012725, which comprise a hyper-branched polymer, an antimicrobially active compound as well as an optional polyester resin. A quaternary ammonium salt is also cited as a possible employable antimicrobial compound. Also here, however, no polymers are described that possess the inventively advantageous structure of hydrophobic regions in combination with antimicrobially active regions, which would make possible the inventive advantageous semi-permanent attachment.

Consequently, a first subject matter of the present invention is hyper-branched polymers comprising a hydrophobic core as well as an antimicrobially and/or anti-adhesively active shell.

According to the invention, “core” is understood to mean the interior of the hyper-branched polymer. In this sense the core includes firstly the hyper-branched core itself, i.e., that region that serves as the root for the development of the hyper-branched polymer; moreover, according to the invention, the term “core” also optionally includes those regions on the branches of the hyper-branched polymer, which connect up to this hyper-branched core, namely when these regions are hydrophobic regions. According to the invention, the terms “core” and “hyper-branched core” can therefore diverge, wherein the core of the hyper-branched polymer in the actual sense includes the hyper-branched core.

The hydrophobic region of the hyper-branched polymer can now be located both in the hyper-branched core alone as well as also, moreover, in the regions of the branches that are directly attached thereto.

In a preferred embodiment, the hydrophobic region is located only in the hyper-branched core itself. In this embodiment, the “hydrophobic core” of the hyper-branched polymer concerns the hyper-branched core itself, such that in this embodiment, the meanings of “core” and “hyper-branched core” are identical.

In another preferred embodiment, the hydrophobic region is located not only in the hyper-branched core, rather moreover, in the regions of the branches that are directly attached thereto. In this embodiment, the meanings of “core” and “hyper-branched core” are correspondingly different.

By “shell” one now understands a region that is attached onto the core of the polymer going from inside to outside. The shell is appropriately formed by antimicrobially and/or anti-adhesively active regions that are located on the branches of the hyper-branched polymer. Depending on the embodiment, the antimicrobially and/or anti-adhesively active shell can be attached directly to the hyper-branched core or be localized further outwards on the hyper-branched polymer; the latter especially then when hydrophobic regions are attached to the hyper-branched core.

The hydrophobic region is preferably formed by silicone groups or by hydrophobic hydrocarbons, which can also optionally comprise heteroatoms. The hydrophobic hydrocarbon can be an optionally substituted polyacrylate or polymethacrylate, for example. As stated, the hydrophobic region can be limited to the hyper-branched core or on the other hand can also extend into the branches of the polymer. The hydrophobic region preferably consists of monomers that are arranged together in blocks.

In an inventively preferred embodiment, the hydrophobic core comprises aromatic groups: C₆₋₁₀ aryl, especially phenyl.

In a particular embodiment, only the hyper-branched core comprises aromatic C₆₋₁₀ aryl groups. In order for the hydrophobicity of the molecule to be sufficient, in this embodiment the number of the hydrophobic groups comprised in the core should preferably be at least 15 or 20, particularly preferably at least 30, 40 or 50, above all at least 100, 120 or 150.

In another preferred embodiment, branches are linked to the hydrophobic core of the hyper-branched polymer, said branches themselves comprising hydrophobic regions with aromatic C₆₋₁₀ aryl groups, on which from inside to outside are attached antimicrobially and/or anti-adhesively active regions. The hydrophobic regions in the branches are in this case preferably polymeric units of at least 10 or 20, preferably at least 30, 40 or 50, particularly preferably at least 70, 100 or 150, in particular 10 to 5000, 50 to 3000 or 100 to 2000 monomers arranged in blocks. The aromatic groups can optionally be mono- or polysubstituted, especially by hydrophobic groups, above all by C₁₋₆ alkyl groups. Phenyl groups are preferred aromatic groups. In a preferred embodiment, the hydrophobic regions of the branches consist of optionally modified polystyrene units having the above-cited numbers of monomers.

Naturally, according to the invention, the hydrophobic core of the hyper-branched polymer can also be formed by different hydrophobic regions. Thus, it is possible for example that the hyper-branched core consists of a silicone, polyacrylate or polymethacrylate, on to which are attached branches that carry aromatic C₁₋₆ aryl groups.

The antimicrobially and/or anti-adhesively active region of the hyper-branched polymer towards microorganisms is preferably the external shell of the polymer. This region is preferably hydrophilic and thereby renders the polymer soluble in aqueous medium. The antimicrobially and/or anti-adhesively active regions are preferably likewise formed by monomers arranged in blocks, such that the hyper-branched polymer is preferably a hyper-branched block copolymer. In the context of the present invention, “anti-adhesive” especially means that the polymers prevent the attachment of microorganisms, preferably bacteria and/or fungi.

The units arranged together in blocks, which each form a hygienically active region, i.e., an antimicrobially and/or anti-adhesively active region, do not themselves in this case have to be antimicrobially and/or anti-adhesively active. It is sufficient and preferred if it is not the individual units themselves, but rather only the block polymeric structure that is antimicrobially and/or anti-adhesively active against microorganisms. Examples of inventively employable antimicrobially active substances or polymeric regions are cited in Tashiro, Macromol. Mater. Eng. (2001) 286, 63-87, particularly in chapter 4. Some of the polymer units cited here first develop antimicrobial and/or anti-adhesive activity against microorganisms after polymerization of the monomers and optional subsequent chemical modification. As a preferred example for this, we may particularly cite monomers that contain pyridine groups, which form polymeric regions having antimicrobial activity only after polymerization and subsequent quaternization of the nitrogen atom.

As examples in this sense of antimicrobially and/or anti-adhesively active polymers may be cited in particular, polymers that carry the biguanide groups or alkylated heteroatomic groups, in particular quaternary ammonium groups, quaternary pyridinium groups, quaternary phosphonium groups or tertiary sulfonium groups.

Alternatively however, the antimicrobially active region can naturally also comprise units that are themselves already antimicrobially and/or anti-adhesively active against microorganisms, these are then preferably also in blocks although this is not mandatory as the antimicrobial action in this embodiment can also be given without a block-type arrangement.

The antimicrobially and/or anti-adhesively active regions can also concern oligosaccharides for example, as is described in, e.g., WO 98/26662, or chitin or chitosan derivatives. However, a disadvantage of hyper-branched polymers modified by carbohydrates consists in that the carbohydrates generally only allow specific interactions with bacteria, and therefore the use of carbohydrates can limit the spectrum of the antibacterial activity.

In the case that the antimicrobially and/or anti-adhesively active regions of the hyper-branched polymer against microorganisms concern a polymeric unit, then this preferably consists of at least 20, 30, 40 or 80, preferably at least 120, 160 or 200, particularly preferably at least 280, 400 or 600, in particular of 40 to 20,000, 200 to 12000 or 400 to 8000, optionally chemically modified monomers arranged in blocks. The optionally chemically modified monomers arranged in blocks preferably concern, according to the previous statements, units that include a group having an alkylated positively charged heteroatom, wherein the groups having an alkylated positively charged heteroatom are preferably selected from quaternary ammonium ions, quaternary pyridinium ions, quaternary phosphonium ions or ternary sulfonium ions. The quaternized or ternized groups are preferably C₁₋₁₂ alkyls, particularly preferably C₁₋₆ alkyls in this case. Consequently, the antimicrobial and/or anti-adhesively active polymeric units preferably concern polycations, especially heteroatomic polycations. In a preferred embodiment, the antimicrobially and/or anti-adhesively active units against microorganisms are the at least partially C₁₋₁₂ alkyl-, particularly preferably C₁₋₆ alkyl-, preferably methyl-, ethyl-, propyl- or butyl-quaternized polyvinylpyridines, especially poly-4-vinylpyridines, or poly(m)ethacrylates that carry nitrogen groups.

The poly(m)ethacrylates that carry nitrogen groups can be manufactured by employing in particular monomers of the following general Formula:

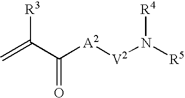

wherein R³ stands for hydrogen, methyl or ethyl, A² for O or NH and V² for a linear or branched, saturated or unsaturated hydrocarbon group containing 1 to 15 carbon atoms and R⁴ and R⁵ independently of one another stand for methyl or ethyl.

In particular, dimethylaminoethyl acrylate, dimethylaminoethyl methacrylate (DMEMA), dimethylaminopropyl acrylate, dimethylaminopropyl methacrylate, dimethylaminobutyl acrylate, dimethylaminobutyl methacrylate, diethylaminoethyl acrylate, diethylaminoethyl methacrylate, dimethylaminoethylacrylamide, dimethylaminoethylmethacrylamide, dimethylaminopropylacrylamide (DMAPA), dimethylaminopropylmethacrylamide (DMAPMA), dimethylaminobutylacrylamide, dimethylaminobutylmethacrylamide, diethylaminoethylacrylamide or diethylaminoethylmethacrylamide can be used as vinyl monomers of this general Formula.

The ratio between the number of monomers in the antimicrobially and/or anti-adhesively active region to the number of monomers in the hydrophobic region is preferably at least 2:1, particularly preferably at least 3:1, especially at least 4:1 or 5:1 and in particular embodiments at least 6:1 or 8:1, wherein the upper limit is preferably 100:1, particularly preferably 50:1, above all 30:1, especially 25:1. In a particularly preferred embodiment, the ratio is between 10:1 and 30:1, especially between 15:1 and 25:1.

The hyper-branched polymer preferably includes at least 3, especially 3 to 10,000, particularly preferably 3 to 1000, in particular 3 to 100 or 3 to 10 branches. The hyper-branched polymer can be a dendrimer; in a preferred embodiment, however, it is a hyper-branched polymer with a low degree of branching. In a particularly preferred embodiment, only the hyper-branched core is branched, whereas the branches that are attached to the hyper-branched core are linear. The degree of branching of the hyper-branched core is preferably from 0.4 to 0.8, particularly preferably from 0.4 to 0.5. (In regard to the definition of the degree of branching, see for example Hölter et al. (1997) Acta Polymer 48, 30-35). The branches that are attached to the hyper-branched core are, as already mentioned, preferably block copolymer units. In a preferred embodiment, the molecular weight of the hyper-branched polymer is from 40,000 to 200,000 g/mol.

The inventively hyper-branched polymer is moreover preferably a water-soluble molecule that in particular can also be stably solubilized in aqueous media in the presence of surfactants. Surprisingly this also applies in particular for inventive hyper-branched polymers with a cationically charged shell in the presence of anionic surfactants, although generally, polymers with cationic groups precipitate out in the presence of anionic surfactants.

Furthermore, the inventive hyper-branched polymers are preferably amphoteric molecules, in so far as at least two different conformational states can be formed. In the dissolved state in aqueous medium, the hydrophobic core is found at the interior of the molecule, whereas the antimicrobially active units are aligned towards the exterior into the aqueous medium. Contact with a hydrophobic surface causes the structure to fold back, such that the conformation changes: the hydrophobic core binds to the hydrophobic surface and the antimicrobially active regions point away from the surface and thereby act antimicrobially and/or anti-adhesively against microorganisms.

Another particular advantage of the inventive hyper-branched polymers is the fact that the inventive hyper-branched polymers can serve as carriers, especially for hydrophobic substances. Biocides, especially triclosan, colorants and fragrances may be cited as examples of such substances. Accordingly, a subject matter of the present invention is also inventive hyper-branched polymers comprising non-covalently bonded active substances, wherein the active substances are preferably selected from biocides, colorants and fragrances.

The hyper-branched polymers can be obtained from a hyper-branched core having a plurality of living centers, in particular by anionic, cationic or radical block copolymerization. The hyper-branched core itself can likewise be obtained by polymerization. In regard to suitably relevant literature on anionic polymerization, reference may be made in particular to the publication of Hadjichristidis et al. in Chem. Rev. (2001) 101, 3747-3792. In regard to literature on radical polymerization, reference may be made for example, to the publications of Kamigaito et al. in Chem. Rev. (2001) 101, 3689-3745, Hawker et al. in Chem. Rev. (2001) 101, 3661-3688 and Matyjaszewski et al. in Chem. Rev. (2001) 101, 2921-2990; in regard to literature on cationic polymerization, to the publications of Charleux et al. in Advances in Polymer Science (1999) 142, 1-69.

Accordingly, a subject matter of the present invention is a process for manufacturing an inventive antimicrobially and/or anti-adhesively active hyper-branched polymer involving the following steps:
a) Manufacturing a hyper-branched core having a plurality of living centers,
b) Treating the compounds according to (a) with monomers that carry quaternary ammonium groups, quaternary phosphonium groups or ternary sulfonium groups.

Accordingly, a subject matter of the present invention is also a process for manufacturing an inventive antimicrobially and/or anti-adhesively active hyper-branched polymer involving the following steps:
a) Manufacturing a hyper-branched core having a plurality of living centers,
b) Treating the compounds according to (a) with monomers that comprise bonded nitrogen, phosphorus or sulfur, wherein the nitrogen-containing group is preferably pyridine,
c) Treating the product from b) with an alkylating agent, wherein the alkylating agent is preferably an alkyl halide, particularly an alkyl chloride, alkyl bromide or alkyl iodide, particularly preferably a C₁₋₆ alkyl halide, most preferably a C₁₋₄ alkyl halide, in order to convert the heteroatom cited in b) into a quaternary or ternary heteroatom.

Accordingly, a subject matter of the present invention is also a process for manufacturing an inventive antimicrobially and/or anti-adhesively active hyper-branched polymer involving the following steps:
a) Manufacturing a hyper-branched core having a plurality of living centers,
b) Treating the compound according to a) with monomers that carry hydrophobic groups, wherein the hydrophobic groups are preferably C₆₋₁₀ aryl aromatic groups and wherein the aromatic groups can optionally be also monosubstituted or polysubstituted by hydrophobic groups, particularly by C₁₋₆ alkyls,
c) Treating the products according to (b) with monomers that carry quaternary ammonium groups, quaternary phosphonium groups or ternary sulfonium groups.

Accordingly, a subject matter of the present invention is also a process for manufacturing an inventive antimicrobially and/or anti-adhesively active hyper-branched polymer involving the following steps:
a) Manufacturing a hyper-branched core having a plurality of living centers,
b) Treating the compound according to a) with monomers that carry hydrophobic groups, wherein the hydrophobic groups are preferably C₆₋₁₀ aryl aromatic groups and wherein the aromatic groups can optionally be also monosubstituted or polysubstituted by hydrophobic groups, particularly by C₁₋₆ alkyls,
c) Treating the compounds according to (b) with monomers that comprise organically bonded nitrogen, phosphorus or sulfur, wherein the nitrogen-containing group is preferably pyridine,
d) Treating the product from (c) with an alkylating agent, wherein the alkylating agent is preferably an alkyl halide, particularly an alkyl chloride, alkyl bromide or alkyl iodide, particularly preferably a C₁₋₆ alkyl halide, most preferably a C₁₋₄ alkyl halide, in order to convert the heteroatom cited in (c) into a quaternary or ternary heteroatom.

In a preferred embodiment, the hyper-branched core having a plurality of living centers is a polyanion, polycation or polyradical stabilized by mesomeric and/or inductive effects, in particular is a resonance-stabilized polyanion, polycation or polyradical, most preferably is an aromatically stabilized polyanion, polycation or polyradical.

A subject matter of the present invention is also hyper-branched polymers that can be obtained by the abovementioned processes.

In a particularly preferred embodiment, the hyper-branched polymers are manufactured starting from aromatically stabilized polyanions, as for example described in Polymer (2003) 44(8), 2213-2220. The aromatically stabilized anions can be suitably manufactured starting from divinylbenzene or 1,3-diisopropenylbenzene, whereby a limited anionic polymerization is carried out by treatment with an organometallic compound, for example butyllithium, thereby producing a branched polymer core having a plurality of living centers. In this manner a hyper-branched core having hydrophobic aromatic groups is already suitably obtained. If this core is large enough, this can already suffice to enable it to bind to hydrophobic surfaces.

In a particular embodiment of the present invention, by starting from this hydrophobic core and by anionic polymerization with monomers that carry antimicrobial groups, an inventive molecule can now already be obtained that can both bind well to hydrophobic surfaces and also exhibits good microbial properties. The antimicrobial group can be bonded to the core both by copolymerization with other monomers as well as by block polymerization. Other units can optionally be inserted between core and antimicrobial unit, particularly by polymerization. Furthermore, additional units can also be attached to the region having the antimicrobial groups.

In a preferred embodiment, at least one hydrophobic block having aromatic groups is additionally inserted into the molecule in order to increase the hydrophobicity of the molecule and thereby the ability to bind to hydrophobic surfaces. Moreover, this is certainly required for manufacturing such inventive highly-branched macromolecules that, as a result of their manufacture, do not already possess a suitably hydrophobic core

Starting from the anionic polymer core, the hydrophobic block can be incorporated by treating this polymer core with monomers that comprise hydrophobic aromatic groups, especially C₆₋₁₀ aryls, most preferably phenyl groups. The aromatic groups can also be optionally substituted by hydrophobic groups, especially by C₁₋₆ alkyl groups.

A block having antimicrobial activity can now be incorporated by treating the polymer core having hydrophobic aromatic branches, as obtained above, with monomers that carry antimicrobially active groups or groups that can be converted into antimicrobially active groups in a subsequent step. In particular, a block having antimicrobially active quaternary ammonium ions can be manufactured by initial treatment with pyridine-containing monomers and subsequent quaternization of the pyridine groups.

Accordingly, the inventive hyper-branched polymer is particularly preferably a hyper-branched block copolymer that respectively includes on the one hand hydrophobic blocks and on the other hand antimicrobially active blocks.

The aromatically stabilized polymeric anion is preferably manufactured by treating diisopropenylbenzene in an organic solvent, preferably THF (tetrahydrofuran), with an organometallic compound, preferably butyllithium, at a temperature of preferably 20 to 40° C., in particular about 30° C.

The polymeric anion is treated with monomers that carry hydrophobic groups by preferably initially cooling the solution to a temperature between −20 and −40° C., in particular about −30° C., then adding the monomer, wherein the monomer is preferably styrene.

The thus-obtained product is treated with monomers that carry pyridine groups preferably likewise at a temperature between −20 and −40° C., in particular at about −30° C. The pyridine group-containing monomer is preferably 4-vinylpyridine.

Prior to treatment with the alkylating agent, the polymerization reaction is preferably first terminated by for example adding methanol, and working up the resulting hyper-branched block copolymer. The alkylation reaction is preferably carried out at room temperature in an organic solvent, in particular in chloroform.

As an example of the preparation of a hydrophobic hyper-branched core by radical polymerization, may be mentioned the use of vinylbenzyl chloride (VBC) or 2-(2-bromopropionyloxy)ethyl acrylate (BPEA), by which are obtained hyper-branched cores that respectively comprise aromatic groups or polyacrylate groups, and which additionally comprise terminal halide end groups as the starting point for the further radical polymerization (Matyjaszewski et al. in Chem. Rev. (2001) 101, 2981-2982). Hyper-branched polymers according to the invention can likewise be obtained by converting said hyper-branched core under conditions of radical polymerization with acrylates that comprise nitrogen groups that can be alkylated, such as 2-(diethylamino)ethyl methacrylate, followed by conversion of the reaction product with an alkylating agent.

A hydrophobic core comprising a silicone polymer can be manufactured starting from a hyper-branched core together with, for example, hexamethyltrisiloxane and butyllithium as the starter. A styrene block can also be optionally subsequently polymerized onto the silicone polymer (see Zilliox et al. (1975) Macromolecules 8, 573-578). A 4-vinylpyridine block can then be polymerized onto the styrene block which becomes antimicrobially active by subsequent alkylation.

In addition to the hydrophobic region and the antimicrobially and/or anti-adhesively active region, a highly-branched polymer according to the invention can also optionally comprise further units, especially blocks that can be located in particular between the hydrophobic core and the antimicrobially and/or anti-adhesively active shell of the molecule or can even be attached from inside towards the exterior of the antimicrobially and/or anti-adhesively active shell. However, in a preferred embodiment, the branches of the hyper-branched polymers each consist solely of a hydrophobic inner block and an external antimicrobially and/or anti-adhesively active block.

Accordingly, a particular subject matter of the present invention concerns hyper-branched block copolymers that include at least 3, preferably 3 to 10,000, particularly 3 to 1000 branches that each include from the inside to the outside a hydrophobic region each having at least 2, preferably at least 5, particularly at least 25 or at least 40 monomers arranged together having aromatic C₆₋₁₀ aryl aromatic groups as well as a subsequent antimicrobially and/or anti-adhesively active region linked thereon towards the exterior, each including at least 8, preferably at least 20, in particular at least 100 or at least 150 units arranged together, wherein the aromatic groups can also be optionally monosubstituted or polysubstituted by hydrophobic groups, especially by C₁₋₆ alkyls, and wherein the units arranged together in the antimicrobially active region preferably concern positively charged organic groups, especially quaternized pyridine groups (pyridinium groups).

A further subject matter of the present invention is the use of the inventive hyper-branched polymers, especially the hyper-branched block copolymers, for treating and/or providing antimicrobial characteristics of surfaces. In this case, the surfaces can be any type of surface. Principally, hydrophobic surfaces are concerned, however hydrophilic or positively or negatively charged surfaces or metallic surfaces can also be treated and/or provided with inventive hyper-branched polymers. As examples of treatable surfaces may be cited surfaces especially in the household, textiles, particularly of synthetic materials, the hair or teeth surfaces. As examples of treatable materials may be cited in particular ceramic surfaces and plastic surfaces as well as wood and metals.

Accordingly, the inventive hyper-branched polymers are preferably comprised in formulations for cleaning surfaces, particularly hard surfaces, especially in automatic dishwasher detergents or dish washing detergents, in laundry detergents or other cleaning agents, in hair-care products, especially in shampoos, or in dental products, especially in toothpastes.

Accordingly, a further subject matter of the present invention is the use of the inventive hyper-branched polymers in a cleaning agent, particularly in an agent for cleaning hard surfaces, especially in automatic dishwasher detergents or dish washing detergents, in laundry detergents or other cleaning agents, in hair-care products, especially in shampoos, or in dental products, especially in toothpastes.

Accordingly, a further subject matter of the present invention is also compositions, especially cleaning agents and/or finishing agents, in particular agents for cleaning and/or finishing hard surfaces, especially an automatic dishwasher detergent or dish washing detergent, a laundry detergent or another cleaning agent, furthermore a hair-care product, especially a shampoo as well as dental products, especially a toothpaste, comprising inventive hyper-branched polymers, especially hyper-branched block copolymers. The cleaning agent and/or finishing agent preferably concern(s) a liquid, gelled or pasty aqueous cleaning agent.

Inventive compositions comprise the inventive hyper-branched block copolymers preferably in amounts of up to 20 wt. %, particularly in amounts of 0.01 to 10.0 wt. % and particularly preferably in amounts of 0.1 to 3.0 wt. %.

In a preferred embodiment, the inventive composition is a cleaning agent for hard surfaces or a laundry detergent for fabrics. Consequently, both of these embodiments will be described below in more detail. Naturally, the components cited below can also be comprised however in other inventive compositions.

The inventive laundry detergents and cleaning compositions can refer to all the various possible types of cleaning compositions, both concentrates and compositions to be used without dilution, for use on a commercial scale in washing machines or in hand washing or manual cleaning. These include, for example, laundry detergents for fabrics, carpets or natural fibers, for which the term “laundry detergent” is used in the present invention. These also include, for example, dishwashing detergents for dishwashing machines or manual dishwashing detergents or cleaners for hard surfaces, such as metal, glass, china, ceramic, tiles, stone, painted surfaces, plastics, wood or leather, for which the term “cleaning composition” is used in the present invention. In the broader sense, sterilisation compositions and disinfectants are also to be regarded as laundry detergents and cleaning compositions in the context of the invention.

Embodiments of the present invention include all types established by the prior art and/or all required usage forms of the inventive laundry detergents or cleaning compositions. These include for example solid, powdered, liquid, gelled or pasty agents, optionally from a plurality of phases, compressed or non-compressed; further included are for example: extrudates, granulates, tablets or pouches, both in bulk and also packed in portions.

In addition to inventive hyper-branched polymers, an inventive laundry detergent or cleaning composition optionally comprises further ingredients such as enzymes, enzyme stabilizers, surfactants, e.g., non-ionic, anionic and/or amphoteric surfactants, and/or bleaching agents, and/or builders, as well as optional further usual ingredients, which are described below.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. In particular, however, alcohol ethoxylates with linear alcohol groups of natural origin with 12 to 18 carbon atoms, e.g., from coco-, palm-, tallow- or oleyl alcohol, and an average of 2 to 8 EO per mole alcohol are preferred. Exemplary preferred ethoxylated alcohols include C₁₂₋₁₄ alcohols with 3 EO or 4EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, as well as mixtures of C₁₂₋₁₄ alcohol with 3 EO and C₁₂₋₁₈ alcohol with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO.

Another class of preferred non-ionic surfactants which may be used, either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain, in particular fatty acid methyl esters.

A further class of non-ionic surfactants, which can be advantageously used, are the alkyl polyglycosides (APG). Suitable alkyl polyglycosides satisfy the general Formula RO(G)_{z} where R is a linear or branched, particularly 2-methyl-branched, saturated or unsaturated aliphatic group containing 8 to 22, preferably 12 to 18 carbon atoms and G is the symbol that stands for a glycose unit containing 5 or 6 carbon atoms, preferably for glucose. Here, the degree of glycosidation z is between 1.0 and 4.0, preferably between 1.0 and 2.0 and particularly between 1.1 and 1.4. Linear alkyl polyglucosides are preferably employed, i.e., alkyl polyglycosides, in which the polyglycosyl group is a glucose group and the alkyl group is an n-alkyl group.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity of these non-ionic surfactants is preferably no more than the quantity in which the ethoxylated fatty alcohols are used and, particularly no more than half that quantity.

Other suitable surfactants are polyhydroxyfatty acid amides corresponding to the Formula (I),

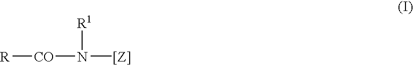

in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the Formula (II),

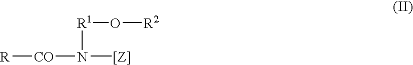

in which R stands for a linear or branched alkyl or alkenyl group containing 7 to 12 carbon atoms, R¹ for a linear, branched or cyclic alkyl group or an aryl group containing 2 to 8 carbon atoms and R² for a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

[Z] is preferably obtained by reductive amination of a sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

Exemplary suitable anionic surfactants are those of the sulfonate and sulfate type. Suitable surfactants of the sulfonate type are, advantageously C₉₋₁₃ alkylbenzene sulfonates, olefin sulfonates, i.e., mixtures of alkene- and hydroxyalkane sulfonates, and disulfonates, as are obtained, for example, from: C₁₂₋₁₈ monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, followed by hydrolysis or neutralization, are also suitable. The esters of α-sulfofatty acids (ester sulfonates), e.g., the α-sulfonated methyl esters of hydrogenated coco-, palm nut- or tallow acids are likewise suitable.

Further suitable anionic surfactants are sulfated fatty acid esters of glycerine. Fatty acid glycerine esters are understood to include the mono-, di- and triesters and also their mixtures, such as those obtained by the esterification of a monoglycerine with 1 to 3 moles fatty acid or by the transesterification of triglycerides with 0.3 to 2 moles glycerine. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali metal and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petrochemical basis and Which show similar degradation behaviour to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of laundry performance. 2,3-Alkyl sulfates are also suitable anionic surfactants.

Sulfuric acid mono-esters derived from straight-chain or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO. Due to their high foaming performance, they are only used in fairly small quantities in cleaning compositions, for example in amounts of up to 5% by weight, usually from 1 to 5% by weight.

Other suitable anionic surfactants are also the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates comprise C₈₋₁₈ fatty alcohol groups or mixtures of them. Especially preferred sulfosuccinates comprise a fatty alcohol group derived from ethoxylated fatty alcohols and may be considered as non-ionic surfactants (see description above). Once again the particularly preferred sulfosuccinates are those, whose fatty alcohol groups are derived from ethoxylated fatty alcohols with narrow range homolog distribution. It is also possible to use alk(en)ylsuccinic acids with preferably 8 to 18 carbon atoms in the alk(en)yl chain, or salts thereof.

Soaps in particular can be considered as further anionic surfactants. Saturated fatty acid soaps are suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid.

Anionic surfactants, including the soaps, may be in the form of their sodium, potassium or ammonium salts or as soluble salts of organic bases, such as mono-, di- or triethanolamine. Preferably, the anionic surfactants are in the form of their sodium or potassium salts, especially in the form of the sodium salts.

The surfactants can be comprised in the inventive cleaning compositions or laundry detergents in a total amount of preferably 5 to 50 wt. %, particularly 8 to 30 wt. %, based on the finished composition.

The inventive laundry detergents or cleaning compositions can comprise bleaching agent. Among the compounds, which serve as bleaches and liberate H₂O₂ in water, sodium percarbonate, sodium perborate tetrahydrate and sodium perborate monohydrate are of particular importance. Examples of further bleaching agents that may be used are peroxypyrophosphates, citrate perhydrates and H₂O₂-liberating peracidic salts or peracids, such as persulfates or persulfuric acid. The urea peroxyhydrate percarbamide that can be described by the formula H₂N—CO—NH₂—H₂O₂ is also suitable. Particularly when agents are used to clean hard surfaces, for example in automatic dishwashers, they can, if desired, also comprise bleaching agents from the group of the organic bleaching agents, although in principal they can also be used for washing textiles. Typical organic bleaching agents are the diacyl peroxides, such as, e.g., dibenzoyl peroxide. Further typical organic bleaching agents are the peroxy acids, wherein the alkylperoxy acids and the arylperoxy acids may be named as examples. Preferred representatives that can be added are peroxybenzoic acid and ring-substituted derivatives thereof, such as alkyl peroxybenzoic acids, but also peroxy-α-naphthoic acid and magnesium monoperphthalate, the aliphatic or substituted aliphatic peroxy acids, such as peroxylauric acid, peroxystearic acid, ε-phthalimido peroxycaproic acid [phthalimido peroxyhexanoic acid PAP)], o-carboxybenzamido peroxycaproic acid, N-nonenylamido peradipic acid and N-nonenylamido persuccinates and aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyl-di(6-amino percaproic acid).

The bleaching agent content of the laundry detergent or cleaning composition is preferably 1 to 40 wt. % and particularly 10 to 20 wt. %, perborate monohydrate or percarbonate being advantageously used.

The preparations can also comprise bleach activators in order to achieve an improved bleaching action for washing temperatures of 60° C. and below and particularly during the pre-treatment wash. Bleach activators, which can be used, are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular 1,3,4,6-tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), acylated hydroxycarboxylic acids, such as triethyl-O-citrate (TEOC), carboxylic acid anhydrides, in particular phthalic anhydride, acylated polyhydric alcohols, in particular triacetin, ethylene glycol diacetate and 2,5-diacetoxy-2,5-dihydrofuran and the enol esters known from the German Patent applications DE 196 16 693 and DE 196 16 767 and acetylated sorbitol and mannitol or their mixtures (SORMAN) described in the European Patent application EP 0 525 239, acylated sugar derivatives, in particular pentaacetyl glucose (PAG), pentaacetyl fructose, tetraacetyl xylose and octaacetyl lactose as well as acetylated, optionally N-alkylated glucamine and gluconolactone, triazole or triazole derivatives and/or particulate caprolactams and/or caprolactam derivatives, preferably N-acylated lactams, for example N-benzoyl caprolactam and N-acetyl caprolactam. Hydrophilically substituted acyl acetals and acyl lactams are also preferably used. Combinations of conventional bleach activators may also be used. Nitrile derivatives such as cyanopyridines, nitrilequats, for example N-alkylammonium acetonitrile, and/or cyanamide derivatives can also be used. Preferred bleach activators are sodium 4-(octanoyloxy)benzene sulfonate, n-nonanoyl- or isononanoyloxybenzene sulfonate (n- or iso-NOBS), undecenoyloxybenzene sulfonate (UDOBS), sodium dodecanoyloxybenzene sulfonate (DOBS), decanoyloxybenzoic acid (DOBA, OBC 10) and/or dodecanoyloxybenzene sulfonate (OBS 12), and N-methylmorpholinum acetonitrile (MMA).

In the context of the present application, further preferred added bleach activators are compounds from the group of the cationic nitriles, particularly cationic nitriles of the Formula

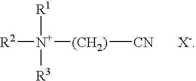

in which R¹ stands for —H, —CH₃, a C₂₋₂₄ alkyl or alkenyl group, a substituted C₂₋₂₄ alkyl or alkenyl group having at least one substituent from the group of —Cl, —Br, —OH, —NH₂, —CN, an alkyl or alkenylaryl group having a C₁₋₂₄ alkyl group or for a substituted alkyl or alkenylaryl group having a C₁₋₂₄ alkyl group and at least a further substituent on the aromatic ring, R² and R³, independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion.

A cationic nitrile of the following Formula is particularly preferred

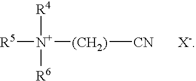

in which R⁴, R⁵ and R⁶ independently of one another are selected from —CH₃, —CH₂—CH₃, —CH₂—CH₂—, —CH(—CH₃)CH₃, wherein R⁴ can also be —H and X is an anion, wherein preferably R⁵═R⁶═—CH₃ and in particular R⁴═R⁵═R⁶═—CH₃ and compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻ are particularly preferred, wherein once again the cationic nitrile of the formula (CH₃)₃N⁽⁺⁾CH₂—CN X⁻, in which X⁻ stands for an anion selected from the group chloride, bromide, iodide, hydrogen sulfate, methosulfate, p-toluene sulfonate (tosylate) or xylene sulfonate.

The bleach activator is comprised in the inventive laundry detergents and cleaning compositions in an amount of 0.01 to 20 wt. %, preferably in an amount of 1 to 10 wt. %, above all in an amount of 2 to 5 wt. %, based on the total composition.

In addition to, or instead of the conventional bleach activators mentioned above, so-called bleach catalysts may also be comprised. These substances are bleach-boosting transition metal salts or transition metal complexes. In particular, manganese, iron, cobalt, ruthenium, molybdenum, titanium or copper in various oxidation states are suitable transition metal complexes. In particular, guanidines (Sundermeyer et al., Journal of Molecular Catalysis A: Chemical (2001) 175, 51-63), aminophenols, amine oxides (WO97/48786), salenes (EP0846156, EP0630964), saldimines (EP912690), heterocycles of the phenanthroline type (Chem. Rev. (2005) 105, 2329-2363), lactams (EP1520910), monocyclic and cross-bridged polycyclic polyazaalkanes (EP0458397, EP977828), terpyridines (WO02/088289), dendrimers (EP1148117), tetraamido ligands (EP918840), bis- and tetrakis(pyridylmethyl)alkylamines (EP783035), further N-containing heterocycles (EP1445305, EP0765381), secondary amines (EP0892846), polyoxometallates (EP0761809) as well as further possible ligands are described in the literature as complexing ligands.

Salen complexes or carbonyl complexes of Mn, Fe, Co, Ru or Mo as well as Mn—, Fe—, Co—, Ru—, Mo—, Ti—, V— and Cu— complexes with N-containing tripod ligands, and Co—, Fe—, Cu— and Ru— amine complexes should be especially cited.

Complexes of manganese in the valence state II, III, IV or V are particularly preferably employed, which preferably comprise one or a plurality of macrocyclic ligands with the donor functions N, NR, PR, O and/or S. Ligands having nitrogen donor functions are preferably employed. In this regard, it is particularly preferred to incorporate bleach catalysts into the compositions according to the invention, which comprise 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN) as the macromolecular ligands. Suitable manganese complexes are for example [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)S, [Mn^{IV}₂(μ-O)₃(Me-TACN)₂](PF₆)₂ and [Mn^{IV}₂(μ-O)₃(Me/Me-TACN)₂](PF₆)₂ (OAc═OC(O)CH₃).

Bleach catalysts can be added in usual amounts, preferably in an amount of up to 5 wt. %, particularly from 0.0025 wt. % to 1 wt. % and particularly preferably from 0.01 to 0.25 wt. %, each based on the total weight of the laundry detergent or cleaning composition. However, in special cases more bleach activator may also be employed.

Generally, inventive laundry detergents or cleaning agents comprise one or more builders, in particular zeolites, silicates, carbonates, organic cobuilders and—where there are no ecological grounds against their use—also phosphates. The last are particularly preferred builders employed in cleaning compositions for automatic dishwashers.

Suitable silicate builders are the crystalline, layered sodium silicates corresponding to the general formula NaMSiₓO₂ₓ₊₁yH₂O, wherein M is sodium or hydrogen, x is a number from 1 to 6. preferably 1.9 to 4.0 and y is a number from 0 to 20, preferred values for x being 2, 3 or 4. These types of crystalline layered silicates are described, for example, in the European Patent application EP 0 164 514. Preferred crystalline layered silicates of the given formula are those in which M stands for sodium and x assumes the values 2 or 3. Both β- and also δ-sodium disilicates Na₂Si₂O₅ yH₂O are particularly preferred. These types of compounds are commercially available, for example, under the designation SKS® (Clariant). SKS-6® is mainly a δ-sodium disilicate with the formula Na₂Si₂O₅ ̂yH₂O, and SKS-7° is mainly the β-sodium disilicate. On reaction with acids (e.g., citric acid or carbonic acid), δ-sodium silicate affords Kanemit NaHSi₂O₅ yH₂O, commercially available under the trade names SKS-9® and SKS-10® (Clariant). It can also be advantageous to chemically modify these layered silicates. The alkalinity, for example, of the layered silicates can be suitably modified. In comparison with the δ-sodium disilicate, layered silicates, doped with phosphate or carbonate, exhibit a different crystal morphology, dissolve more rapidly and show an increased calcium binding ability. Thus, layered silicates of the general formula x Na₂O y SiO₂ z P₂O₅ in which the ratio x to y corresponds to a number 0.35 to 0.6, the ratio x to z a number from 1.75 to 1200 and the ratio y to z a number from 4 to 2800, are described in the patent application DE 196 01 063. The solubility of the layered silicates can also be increased by employing particularly finely dispersed layered silicates. Compounds of the crystalline layered silicates with other ingredients can also be used. Compounds with cellulose derivatives, which possess advantages in the disintegration action, and which are particularly used in detergent tablets, as well as compounds with polycarboxylates, for example citric acid or polymeric polycarboxylates, for example copolymers of acrylic acid can be particularly cited in this context.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflexes typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is to be interpreted to mean that the products have microcrystalline regions between 10 and a few hundred nm in size, values of up to at most 50 nm and especially up to at most 20 nm being preferred. Compacted/densified amorphous silicates, compounded amorphous silicates and over dried X-ray-amorphous silicates are particularly preferred.

An optionally suitable fine crystalline, synthetic zeolite containing bound water, is preferably zeolite A and/or P. Zeolite MAP® (commercial product of the Crosfield company), is particularly preferred as the zeolite P. However, zeolite X and mixtures of A, X and/or P are also suitable. Commercially available and preferably used in the context of the present invention is, for example, also a co-crystallizate of zeolite X and zeolite A (ca. 80 wt. % zeolite X), which is marketed by CONDEA Augusta S.p.A. under the trade name VEGOBOND AX® and which can be described by the Formula

nNa₂O(1−n)K₂O Al₂O₃(2−2.5)SiO₂(3.5−5.5) H₂O.

Suitable zeolites have a mean particle size of less than 10 μm (volume distribution, as measured by the Coulter Counter Method) and contain preferably 18 to 22% by weight and more preferably 20 to 22% by weight of bound water.

Naturally, the generally known phosphates can also be added as builders, in so far that their use should not be avoided on ecological grounds. In the detergent and cleaning agent industry, among the many commercially available phosphates, the alkali metal phosphates are the most important and pentasodium or pentapotassium triphosphates (sodium or potassium tripolyphosphate) are particularly preferred.

“Alkali metal phosphates” is the collective term for the alkali metal (more particularly sodium and potassium) salts of the various phosphoric acids, in which metaphosphoric acids (HPO₃)ₙ and orthophosphoric acid (H₃PO₄) and representatives of higher molecular weight can be differentiated. The phosphates combine several inherent advantages: they act as alkalinity sources, prevent lime deposits on machine parts and lime incrustations in fabrics and, in addition, contribute towards the cleaning effect.

Sodium dihydrogen phosphate NaH₂PO₄ exists as the dihydrate (density 1.91 gcm⁻³, melting point 60° C.) and as the monohydrate (density 2.04 gcm⁻³). Both salts are white, readily water-soluble powders that on heating, lose the water of crystallization and at 200° C. are converted into the weakly acidic diphosphate (disodium hydrogen diphosphate, Na₂H₂P₂O₇) and, at higher temperatures into sodium trimetaphosphate (Na₃P₃O₉) and Maddrell's salt (see below). NaH₂PO₄ shows an acidic reaction. It is formed by adjusting phosphoric acid with sodium hydroxide to a pH value of 4.5 and spraying the resulting “mash”. Potassium dihydrogen phosphate (primary or monobasic potassium phosphate, potassium biphosphate, KDP), KH₂PO₄, is a white salt with a density of 2.33 gcm⁻³, has a melting point of 253° C. [decomposition with formation of potassium polyphosphate (KPO₃)ₓ] and is readily soluble in water.

Disodium hydrogen phosphate (secondary sodium phosphate), Na₂HPO₄, is a colorless, very readily water-soluble crystalline salt. It exists in anhydrous form and with 2 mol (density 2.066 gcm³, water loss at 95° C.), 7 mol (density 1.68 gcm⁻³, melting point 48° C. with loss of 5H₂O) and 12 mol of water (density 1.52 gcm³, melting point 35° C. with loss of 5H₂O), becomes anhydrous at 100° C. and, on fairly intensive heating, is converted into the diphosphate Na₄P₂O₇. Disodium hydrogen phosphate is prepared by neutralization of phosphoric acid with soda solution using phenolphthalein as the indicator. Dipotassium hydrogen phosphate (secondary or dibasic potassium phosphate), K₂HPO₄, is an amorphous white salt, which is readily soluble in water.

Trisodium phosphate, tertiary sodium phosphate, Na₃PO₄, consists of colorless crystals with a density of 1.62 gcm⁻³ and a melting point of 73-76° C. (decomposition) as the dodecahydrate, a melting point of 100° C. as the decahydrate (corresponding to 19-20% P₂O₅) and in anhydrous form (corresponding to 39-40% P₂O₅) a density of 2.536 gcm⁻³. Trisodium phosphate is readily soluble in water with an alkaline reaction and is manufactured by evaporating a solution of exactly 1 mole disodium phosphate and 1 mole NaOH. Tripotassium phosphate (tertiary or tribasic potassium phosphate), K₃PO₄, is a white deliquescent granular powder with a density of 2.56 gcm⁻³, has a melting point of 1340° C. and is readily soluble in water through an alkaline reaction. It is produced by, e.g., heating Thomas slag with carbon and potassium sulfate. Despite their higher price, the more readily soluble and therefore highly effective potassium phosphates are often preferred to corresponding sodium compounds in the detergent industry.

Tetrasodium diphosphate (sodium pyrophosphate), Na₄P₂O₇, exists in anhydrous form (density 2.534 gcm⁻³, melting point 988° C., a figure of 880° C. has also been mentioned) and as the decahydrate (density 1.815-1.836 gcm⁻³, melting point 94° C. with loss of water). Both substances are colorless crystals that dissolve in water with an alkaline reaction. Na₄P₂O₇ is formed when disodium phosphate is heated to more than 200° C. or by reacting phosphoric acid with soda in a stoichiometric ratio and spray drying the solution. The decahydrate complexes heavy metal salts and hardness salts and, hence, reduces the hardness of water. Potassium diphosphate (potassium pyrophosphate), K₄P₂O₇, exists in the form of the trihydrate and is a colorless hygroscopic powder with a density of 2.33 gcm⁻³, which is soluble in water, the pH of a 1% solution at 25° C. being 10.4.

Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. The chain types in particular are known by various different names: fused or calcined phosphates, Graham's salt, Kurrol's salt and Maddrell's salt. All higher sodium and potassium phosphates are known collectively as condensed phosphates.

The industrially important pentasodium triphosphate, Na₅P₃O₁₀ (sodium tripolyphosphate), is anhydrous or crystallizes with 6H₂O to a non-hygroscopic, white, water-soluble salt which has the general formula NaO—[P(O)(ONa)—O]ₙ—Na where n=3. Around 17 g of the salt free from water of crystallization dissolve in 100 g of water at room temperature, around 20 g at 60° C. and around 32 g at 100° C. After heating the solution for 2 hours to 100° C., around 8% orthophosphate and 15% diphosphate are formed by hydrolysis. In the preparation of pentasodium triphosphate, phosphoric acid is reacted with soda solution or sodium hydroxide in a stoichiometric ratio and the solution is spray-dried. Similarly to Graham's salt and sodium diphosphate, pentasodium triphosphate solubilizes many insoluble metal compounds (including lime soaps, etc.). K₅P₃O₁₀ (potassium tripolyphosphate), is marketed for example in the form of a 50% by weight solution (>23% P₂O₅, 25% K₂O). The potassium polyphosphates are widely used in the laundry detergent and cleaning industry. Sodium potassium tripolyphosphates also exist and are also usable in the scope of the present invention. They are formed for example when sodium trimetaphosphate is hydrolyzed with KOH:

(NaPO₃)₃+2KOH—>Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention.

Organic co-builders, which may be used in the detergents and cleaning agents according to the invention, include, in particular, polycarboxylates or polycarboxylic acids, polymeric polycarboxylates, polyaspartic acid, polyacetals, optionally oxidized dextrins, other organic co-builders (see below) and phosphonates. These classes of substances are described below.

Useful organic builders are, for example, the polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of polycarboxylic acids such as citric acid, adipic acid, succinic acid, glutaric acid, tartaric acid, sugar acids and mixtures thereof.

Acids per se can also be used. Besides their building effect, the acids also typically have the property of an acidifying component and, hence also serve to establish a relatively low and mild pH in washing or cleaning agents, when the pH, which results from the mixture of other components, is not wanted. Acids that are system-compatible and environmentally compatible such as citric acid, acetic acid, tartaric acid, malic acid, glycolic acid, succinic acid, glutaric acid, adipic acid, gluconic acid and mixtures thereof are particularly mentioned in this regard. However, mineral acids, particularly sulfuric acid or bases, particularly ammonium or alkali metal hydroxides can also serve as pH regulators. These types of regulators are preferably comprised in the inventive agents in amounts of not more than 20 wt. %, particularly from 1.2 wt. % to 17 wt. %.

Other suitable builders are polymeric polycarboxylates, i.e., for example the alkali metal salts of polyacrylic or polymethacrylic acid, for example those with a relative molecular weight of 500 to 70,000 g/mol.

The molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ significantly from the molecular weights measured against polystyrene sulfonic acids as the standard. The molecular weights measured against polystyrene sulfonic acids are generally significantly higher than the molecular weights mentioned in this specification.

Particularly suitable polymers are polyacrylates, which preferably have a molecular weight of 2000 to 20,000 g/mol. By virtue of their superior solubility, preferred representatives of this group are the short-chain polyacrylates, which have molecular weights of 2000 to 10,000 g/mol and, more particularly, 3000 to 5000 g/mol.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2 000 to 70,000 g/mol, preferably 20,000 to 50,000 g/mol and especially 30,000 to 40,000 g/mol. The (co)polymeric polycarboxylates can be used either as powders or as aqueous solutions. The (co)polymeric polycarboxylate content of the compositions is preferably from 0.5 to 20% by weight, in particular from 1 to 10% by weight.

In order to improve the water solubility, the polymers can also comprise allylsulfonic acids, such as for example, allyloxybenzene sulfonic acid and methallyl sulfonic acid as monomers.

Other particularly preferred polymers are biodegradable polymers of more than two different monomer units, for example those which contain salts of acrylic acid and maleic acid and vinyl alcohol or vinyl alcohol derivatives as monomers or those which contain salts of acrylic acid and 2-alkylallyl sulfonic acid and sugar derivatives as monomers.

Other preferred copolymers are those, which preferably contain acrolein and acrylic acid/acrylic acid salts or acrolein and vinyl acetate as monomers.

Similarly, other preferred builders are polymeric amino dicarboxylic acids, salts or precursors thereof. Polyaspartic acids or their salts and derivatives are particularly preferred.

Further preferred builders are polyacetals that can be obtained by treating dialdehydes with polyol carboxylic acids that possess 5 to 7 carbon atoms and at least 3 hydroxyl groups. Preferred polyacetals are obtained from: dialdehydes like glyoxal, glutaraldehyde, terephthalaldehyde as well as their mixtures and from polycarboxylic acids like gluconic acid and/or glucoheptonic acid.

Further suitable organic builders are dextrins, for example oligomers or polymers of carbohydrates that can be obtained by the partial hydrolysis of starches. The hydrolysis can be carried out using typical processes, for example acidic or enzymatic catalyzed processes. The hydrolysis products preferably have average molecular weights in the range 400 to 500,000 g/mol. A polysaccharide with a dextrose equivalent (DE) of 0.5 to 40 and, more particularly, 2 to 30 is preferred, the DE being an accepted measure of the reducing effect of a polysaccharide by comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2000 to 30,000 g/mol may be used.

The oxidized derivatives of such dextrins concern their reaction products with oxidizing agents that are capable of oxidizing at least one alcohol function of the saccharide ring to the carboxylic acid function. Particularly preferred organic builders for inventive compositions are oxidized starches and their derivatives from the applications EP 472 042, WO 97/25399, and EP 755 944.

Oxydisuccinates and other derivatives of disuccinates, preferably ethylenediamine disuccinate are also further suitable cobuilders. Ethylenediamine-N,N′-disuccinate (EDDS) is preferably used here in the form of its sodium or magnesium salts. In this context, glycerine disuccinates and glycerine trisuccinates are also preferred. Suitable addition quantities in zeolite-containing and/or silicate-containing formulations range between 3 and 15% by weight.

Other useful organic co-builders are, for example, acetylated hydroxycarboxylic acids and salts thereof which may optionally be present in lactone form and which contain at least 4 carbon atoms, at least one hydroxyl group and at most two acid groups.

The phosphonates represent a further class of substances with cobuilder properties. In particular, they are hydroxyalkane phosphonates or aminoalkane phosphonates. Among the hydroxyalkane phosphonates, 1-hydroxyethane-1,1-diphosphonate (HEDP) is of particular importance as the cobuilder. It is normally added as the sodium salt, the disodium salt reacting neutral and the tetrasodium salt reacting alkaline (pH 9). Ethylenediamine tetramethylene phosphonate (EDTMP), diethylenetriamine pentamethylene phosphonate (DTPMP) and their higher homologs are preferably chosen as the aminoalkane phosphonates. They are preferably added in the form of the neutral-reacting sodium salts, e.g., as the hexasodium salt of EDTMP or as the hepta and octasodium salt of DTPMP. Of the class of phosphonates, HEDP is preferably used as the builder. The aminoalkane phosphonates additionally possess a pronounced ability to complex heavy metals. Accordingly, it can be preferred, particularly where the agents also contain bleach, to use aminoalkane phosphonates, particularly DTPMP, or mixtures of the mentioned phosphonates.

In addition, any compounds capable of forming complexes with alkaline earth metal ions may be used as co-builders.

Builders can be comprised in the inventive detergents or cleaning agents optionally in quantities of up to 90% by weight. They are preferably comprised in quantities of up to 75% by weight. Inventive laundry detergents possess builder contents of particularly 5 wt. % to 50 wt. %. In inventive compositions for cleaning hard surfaces, in particular for automatic dishwashing of tableware, the content of builders is particularly 5 wt. % to 88 wt. %, wherein in this type of composition, no water-insoluble builders are employed. In a preferred embodiment, the inventive composition, particularly for automatic dishwashers, comprises 20 wt. % to 40 wt. % of water-soluble organic builders, particularly alkali citrate, 5 wt. % to 15 wt. % alkali carbonate and 20 wt. % to 40 wt. % alkali disilicate.

Solvents that can be added to the liquid to gel-like compositions of laundry detergent and cleaning compositions originate, for example, from the group of mono- or polyhydric alcohols, alkanolamines or glycol ethers, in so far that they are miscible with water in the defined concentrations. Preferably, the solvents are selected from ethanol, n- or i-propanol, butanols, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, dipropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents.

Solvents can be employed in the inventive liquid to gel-like detergents and cleaning compositions in amounts between 0.1 and 20 wt. %, preferably, however below 15 wt. % and particularly below 10 wt. %.

One or more thickeners or thickener systems can be added to the inventive compositions to adjust the viscosity. These high molecular weight substances, which are also called swelling agents, soak up mostly liquids, thereby swelling up and subsequently transform into viscous, real or colloidal solutions.

Suitable thickeners are inorganic or polymeric organic compounds. The inorganic thickeners include, for example, polysilicic acids, mineral clays like montmorillonite, zeolites, silicic acids and bentonites. The organic thickeners come from the groups of natural polymers, derivatives of natural polymers and synthetic polymers. Exemplary, naturally occurring polymers that can be used as thickeners are agar agar, carrageen, tragacanth, gum Arabic, alginates, pectins, polyoses, guar meal, locust tree bean flour, starches, dextrins, gelatines and casein. Modified natural products that are used as thickeners are mainly derived from the group of the modified starches and celluloses. Examples can be cited as carboxymethyl cellulose and other cellulose ethers, hydroxyethyl- and hydroxypropyl cellulose as well as flour ether. Totally synthetic thickeners are polymers such as polyacrylics and polymethacrylics, vinyl polymers, polycarboxylic acids, polyethers, polyimines, -polyamides and polyurethanes.

The thickeners can be comprised in amounts up to 5 wt. %, preferably from 0.05 to 2 wt. %, and particularly preferably from 0.1 to 1.5 wt. %, based on the finished preparation.

The laundry detergents or cleaning compositions according to the invention can optionally comprise further typical ingredients: sequestering agents, electrolytes and further auxiliaries, such as optical brighteners, graying inhibitors, silver corrosion inhibitors, color transfer inhibitors, foam inhibitors, abrasives, dyes and/or fragrances, as well as antimicrobial agents, UV absorbers and/or enzyme stabilizers.

The detergents for textiles may contain derivatives of diaminostilbene disulfonic acid or alkali metal salts thereof as optical brighteners. Suitable optical brighteners are, for example, salts of 4,4′-bis-(2-anilino-4-morpholino-1,3,5-triazinyl-6-amino)stilbene-2,2′-disulfonic acid or compounds of similar structure which contain a diethanolamino group, a methylamino group, an anilino group or a 2-methoxyethylamino group instead of the morpholino group. Optical brighteners of the substituted diphenylstyryl type may also be present, for example the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the mentioned optical brighteners may also be used.

Graying inhibitors have the task of ensuring that the dirt removed from the textile fibers is held suspended in the wash liquid. Water-soluble colloids of mostly organic nature are suitable for this, for example starch, glue, gelatines, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, aldehyde starches, for example, can be used instead of the above-mentioned starch derivatives. Preference, however, is given to the use of cellulose ethers such as carboxymethyl cellulose (Na salt), methyl cellulose, hydroxyalkyl cellulose, and mixed ethers such as methyl hydroxyethyl cellulose, methyl hydroxypropyl cellulose, methyl carboxymethyl cellulose and mixtures thereof, which can be added, for example in amounts of 0.1 to 5 wt. %, based on the agent.

In order to realize a silver corrosion protection, silver protectors for tableware can be added to the inventive cleaning compositions. Benzotriazoles, ferric chloride or CoSO₄, for example are known from the prior art. As is known from the European Patent EP 0 736 084 B1, for example, particularly suitable silver protectors for general use with enzymes are salts and/or complexes of manganese, titanium, zirconium, hafnium, vanadium, cobalt or cerium, in which the cited metals exist in the valence states II, III, IV, V or VI. Examples of these types of compounds are MnSO₄, V₂O₅, V₂O₄, VO₂, TiOSO₄, K₂TiF₆, K₂ZrF₆, Co(NO₃)₂, Co(NO₃)₃ and mixtures thereof.

Soil repellents are mostly polymers that when used in a laundry detergent, lend the fibers soil-repelling properties and/or support the soil repellent capabilities of the conventional ingredients. A comparable effect can also be observed when they are added in cleaning compositions for hard surfaces.

Particularly effective and well-known soil release agents are copolyesters with dicarboxylic acid, alkylene glycol and polyalkylene glycol units. Examples of these are copolymers or mixed polymers of polyethylene terephthalates and polyoxyethylene glycol (DT 16 17 141 and DT 22 00 911). German Offenlegungsschrift DT 22 53 063 cites acid compositions, which inter alia comprise a copolymer of a dibasic acid and an alkylene or cycloalkylene polyglycol. Polymers of ethylene terephthalate and polyethylene oxide terephthalate and their use in laundry detergents are described in the German texts DE 28 57 292 and DE 33 24 258 and the European Patent EP 0 253 567. The European Patent EP 066 944 relates to compositions, which contain a copolyester of ethylene glycol, polyethylene glycol, aromatic dicarboxylic acids and sulfonated aromatic dicarboxylic acids in defined molar ratios. Polyesters, end-capped with methyl or ethyl groups, with ethylene and/or propylene terephthalate units and polyethylene oxide terephthalate units and laundry detergents that comprise such a soil-release polymer are known from EP 0 185 427. The European Patent EP 0 241 984 relates to a polyester, which in addition to oxyethylene groups and terephthalic acid units also comprises substituted ethylene units as well as glycerine units. Polyesters are known from EP 0 241 985 which contain, beside oxyethylene groups and terephthalic acid units, 1,2-propylene, 1,2-butylene and/or 3-methoxy-1,2-propylene groups as well as glycerine units, and are end-capped with C₁ to C₄ alkyl groups. Polyesters with polypropylene terephthalate units and polyoxyethylene terephthalate units, at least partially end-capped with C₁₋₄ alkyl or acyl groups, are known from the European Patent application EP 0 272 033. The European Patent EP 0 274 907 describes soil-release polyesters containing terephthalate end-capped with sulfoethyl groups. According to the European Patent application EP 0 357 280, soil-release polyesters with terephthalate units, alkylene glycol units and poly-C₂₋₄ glycol units are manufactured by sulfonation of the unsaturated end groups. The international patent application WO 95/32232 relates to acidic, aromatic polyesters that are capable of releasing soil. For cotton materials, non-polymeric soil repellent active substances with a plurality of functional units are known from the international patent application WO 97/31085: a first unit, which can be cationic, for example, is able to be adsorbed onto the cotton surface by electrostatic attraction, and a second unit, which is designed to be hydrophobic, is responsible for the retention of the active agent at the water/cotton interface.

Color transfer inhibitors that can be used in inventive laundry detergents for textiles particularly include polyvinyl pyrrolidones, polyvinyl imidazoles, polymeric N-oxides such as polyvinyl pyridine-N-oxide and copolymers of vinyl pyrrolidone with vinyl imidazole.

On using the agents in automatic cleaning processes, it can be advantageous to add foam inhibitors. Suitable foam inhibitors include for example, soaps of natural or synthetic origin, which have a high content of C₁₈-C₂₄ fatty acids. Suitable non-surface-active types of foam inhibitors are, for example, organopolysiloxanes and mixtures thereof with microfine, optionally silanized silica and also paraffins, waxes, microcrystalline waxes and mixtures thereof with silanized silica or bis-stearyl ethylenediamide. Mixtures of various foam inhibitors, for example mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material. Especially in this case, mixtures of paraffins and bis stearylethylene diamides are preferred.

An inventive cleaning composition for hard surfaces can moreover comprise abrasive ingredients, especially from the group comprising quartz meal, wood flour, plastic powder, chalk and microspheres as well as their mixtures. Abrasives are preferably comprised in the inventive cleaning compositions in amounts of not more than 20 wt. %, particularly from 5 wt. % to 15 wt. %.

Colorants and fragrances may be added to the laundry detergents and cleaning compositions in order to improve the esthetic impression created by the products and to provide the consumer not only with the required performance but also with a visually and sensorially “typical and unmistakable” product. Suitable perfume oils or fragrances include individual odoriferous compounds, for example synthetic products of the ester, ether, aldehyde, ketone, alcohol and hydrocarbon type. Odoriferous compounds of the ester type are, for example, benzyl acetate, phenoxyethyl isobutyrate, p-tert-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various odoriferous substances, which together produce an attractive fragrant note, are preferably used. Perfume oils such as these may also contain natural odoriferous mixtures obtainable from vegetal sources, for example pine, citrus, jasmine, patchouli, rose or ylang-ylang oil. Also suitable are muscatel oil, oil of sage, chamomile oil, clove oil, melissa oil, mint oil, cinnamon leaf oil, lime blossom oil, juniper berry oil, vetivert oil, olibanum oil, galbanum oil and laudanum oil and orange blossom oil, neroli oil, orange peel oil and sandalwood oil. Normally the content of dyes lies below 0.01 wt. %, while fragrances can make up to 2 wt. % of the total formulation of the laundry detergent and cleaning compositions.

The fragrances may be directly incorporated in the laundry detergent or cleaning composition, although it can also be of advantage to apply the fragrances on carriers, which reinforce the adsorption of the perfume on the washing and thereby ensuring a long-lasting fragrance on the textiles by decreasing the release of the fragrance, especially for treated textiles. Suitable carrier materials are, for example, cyclodextrins, the cyclodextrin/perfume complexes optionally being coated with other auxiliaries. A further preferred carrier for fragrances is the described zeolite X, which instead of or in mixtures with surfactants can also take up fragrances. Accordingly, preferred laundry detergents and cleaning compositions comprise the described zeolite X and fragrances that are preferably at least partially absorbed on the zeolite.

Preferred colorants, which are not difficult for the expert to choose, have high storage stability, are not affected by the other ingredients of the composition or by light and do not have any pronounced substantivity for the textile fibers being treated, so as not to color them.

To control microorganisms, the laundry detergent or cleaning compositions may contain antimicrobial agents. Depending on the antimicrobial spectrum and the action mechanism, antimicrobial agents are classified as bacteriostatic agents and bactericides, fungistatic agents and fungicides, etc. Important substances from these groups are for example benzalkonium chlorides, alkylaryl sulfonates, halophenols and phenol mercury acetate. In the present context of the inventive teaching, the expressions “antimicrobial activity” and “antimicrobial agent” have the usual technical meanings as defined, for example, by K. H. Wallhausser in “Praxis der Sterilisation, Desinfektion—Konservierung Keimidentifizierung—Betriebshygiene” (5th Edition, Stuttgar/New York: Thieme, 1995), any of the substances with antimicrobial activity described therein being usable. Suitable antimicrobial agents are preferably selected from the groups of alcohols, amines, aldehydes, antimicrobial acids and salts thereof, carboxylic acid esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propyl butyl carbamate, iodine, iodophores, peroxy compounds, halogen compounds and mixtures of the above.

Consequently, the antimicrobial active substances can be chosen among ethanol, n-propanol, i-propanol, 1,3-butanediol, phenoxyethanol, 1,2-propylenelycol, glycerine, undecylenic acid, benzoic acid, salicylic acid, dihydracetic acid, o-phenylphenol, N-methylmorpholine-acetonitrile (MMA), 2-benzyl-4-chlorophenol, 2,2′-methylene-bis-(6-bromo-4-chlorophenol), 4,4′-dichloro-2′-hydroxydiphenyl ether (dichlosan), 2,4,4′-trichloro-2′-hydroxydiphenyl ether (trichlosan), chlorhexidine, N-(4-chlorophenyl)-N-(3,4-dichlorophenyl)-urea, N,N′-(1,10-decanediyldi-1-pyridinyl-4-ylidene)-bis-(1-octamine) dihydrochloride, N,N′-bis-(4-chlorophenyl)-3,12-diimino-2,4,11,13-tetraaza-tetradecanediimideamide, glucoprotamines, surface-active antimicrobial quaternary compounds, guanidines, including the bi- and polyguanidines, such as for example 1,6-bis(2-ethylhexylbiguanidohexane) dihydrochloride, 1,6-di-(N₁,N₁′-phenyldiguanido-N₅,N₅′)hexane tetrahydrochloride, 1,6-di-(N₁,N₁′-phenyl-N₁,N₁′-methyldiguanido-N₅,N₅′)hexane dihydrochloride, 1,6-di-(N₁,N₁′-o-chlorophenyldiguanido-N₅, N₅′)hexane dihydrochloride, 1,6-di-(N₁,N₁′-2,6-dichlorophenyldiguanido-N₅,N₅′)hexane dihydrochloride, 1,6-di-[N₁, N₁′-β-(p-methoxyphenyl) diguanido-N₅, N₅′]hexane dihydrochloride, 1,6-di-(N₁, N₁′-α-methyl-β-phenyldiguanido-N₅, N₅′)hexane dihydrochloride, 1,6-di-(N₁,N₁′-p-nitrophenyldiguanido-N₅,N₅′)hexane dihydrochloride, ω:ω-di-(N₁,N₁′-phenyldiguanido-N₅,N₅′)di-n-propyl ether dihydrochloride, ω:ω-di-(N₁,N₁′-p-chlorophenyldiguanido-N₅, N₅′)di-n-propyl ether tetrahydrochloride, 1,6-di-(N₁,N₁′-2,4-dichlorophenyldiguanido-N₅,N₅′)hexane tetrahydrochloride, 1,6-di-(N₁,N₁′-p-methylphenyldiguanido-N₅,N₅′)hexane dihydrochloride, 1,6-di-(N₁,N₁′-2,4,5-trichlorophenyldiguanido-N₅,N₅′)hexane tetrahydrochloride, 1,6-di-[N₁,N₁′-α-(p-chlorophenyl)ethyldiguanido-N₅,N₅′]hexane dihydrochloride, ω:ω-di-(N₁,N₁′-p-chlorophenyldiguanido-N₅,N₅′)ₘ-xylene dihydrochloride, 1,12-di-(N₁,N₁′-p-chlorophenyldiguanido-N₅,N₅′)dodecane dihydrochloride, 1,10-di-(N₁,N₁′-phenyldiguanido-N₅,N₅′)decane tetrahydrochloride, 1,12-di-(N₁,N₁-phenyldiguanido-N₅, N₅′)dodecane tetrahydrochloride, 1,6-di-(N₁, N₁′-chlorophenyldiguanido-N₅,N₅′)hexane dihydrochloride, 1,6-di-(N₁, N₁′-o-chlorophenyldiguanido-N₅,N₅′)hexane tetrahydrochloride, ethylene-bis-(1-tolylphenylbiguanide), ethylene-bis-(p-tolylphenylbiguanide), ethylene-bis-(3,5-dimethylphenylbiguanide), ethylene-bis-(p-tert-amylphenylbiguanide), ethylene-bis-(nonylphenylbiguanide), ethylene-bis-(phenylbiguanide), ethylene-bis-(N-butylphenylbiguanide), ethylene-bis-(2,5-diethoxyphenylbiguanide), ethylene-bis-(2,4-dimethylphenylbiguanide), ethylene-bis-(o-diphenylbiguanide), ethylene-bis-(mixed amylnaphthylbiguanide), N-butylethylene-bis-(phenylbiguanide), trimethylene bis(o-tolylbiguanide), N-butyltrimethylene-bis-(phenylbiguanide) and the corresponding salts like acetates, gluconates, hydrochlorides, hydrobromides, citrates, bisulfites, fluorides, polymaleates, N-coco alkyl sarcinosates, phosphites, hypophosphites, perfluorooctanoates, silicates, sorbates, salicylates, maleates, tartrates, fumarates, ethylenediaminetetraacetates, iminodiacetates, cinnamates, thiocyanates, arginates, pyromellitates, tetracarboxybutyrates, benzoates, glutarates, monofluorophosphates, perfluoropropionates as well as any mixtures thereof. Furthermore, halogenated xyiene- and cresol derivatives are suitable, such as p-chloro-meta-cresol, p-chloro-meta-xylene, as well as natural antimicrobial active agents of plant origin (e.g., from spices or aromatics), animal as well as microbial origin. Preferred antimicrobial agents are antimicrobial surface-active quaternary compounds, a natural antimicrobial agent of vegetal origin and/or a natural antimicrobial agent of animal origin and, most preferably, at least one natural antimicrobial agent of vegetal origin from the group comprising caffeine, theobromine and theophylline and essential oils, such as eugenol, thymol and geraniol, and/or at least one natural antimicrobial agent of animal origin from the group comprising enzymes, such as protein from milk, lysozyme and lactoperoxidase and/or at least one antimicrobial surface-active quaternary compound containing an ammonium, sulfonium, phosphonium, iodonium or arsonium group, peroxy compounds and chlorine compounds. Substances of microbial origin, so-called bacteriozines, may also be used.

The quaternary ammonium compounds (QUATS) suitable as antimicrobial agents have the general formula (R¹)(R²)(R³)(R⁴)N⁺X⁻, in which R¹ to R⁴ may be the same or different and represent C₁₋₂₂ alkyl groups, C₇₋₂₈ aralkyl groups or heterocyclic groups, two or—in the case of an aromatic compound, such as pyridine—even three groups together with the nitrogen atom forming the heterocycle, for example a pyridinium or imidazolinium compound, and X⁻ represents halide ions, sulfate ions, hydroxide ions or similar anions. In the interests of optimal antimicrobial activity, at least one of the substituents preferably has a chain length of 8 to 18 and, more preferably, 12 to 16 carbon atoms.

QUATS can be obtained by reacting tertiary amines with alkylating agents such as, for example, methyl chloride, benzyl chloride, dimethyl sulfate, dodecyl bromide and also ethylene oxide. The alkylation of tertiary amines having one long alkyl chain and two methyl groups is particularly easy. The quaternization of tertiary amines containing two long chains and one methyl group can also be carried out under mild conditions using methyl chloride. Amines containing three long alkyl chains or hydroxy-substituted alkyl chains lack reactivity and are preferably quaternized with dimethyl sulfate.

Suitable QUATS are, for example, Benzalkonium chloride (N-alkyl-N,N-dimethylbenzyl ammonium chloride, CAS No. 8001-54-5), Benzalkon B (m,p-dichlorobenzyldimethyl-C₁₋₂-alkylammonium chloride, CAS No. 58390-78-6), Benzoxonium chloride (benzyldodecyl-bis-(2-hydroxyethyl)ammonium chloride), Cetrimonium bromide (N-hexadecyl-N,N-trimethylammonium bromide, CAS No. 57-09-0), Benzetonium chloride (N,N-di-methyl-N-[2-[2-[p-(1,1,3,3-tetramethylbutyl)-phenoxy]-ethoxy]-ethyl]-benzylammonium chloride, CAS No. 121-54-0), dialkyldimethylammonium chlorides, such as di-n-decyldimethylammonium chloride (CAS No. 7173-51-5-5), didecyldimethyl ammonium bromide (CAS No. 2390-68-3), dioctyidimethylammonium chloride, 1-cetylpyridinium chloride (CAS No. 123-03-5) and thiazoline iodide (CAS No. 15764-48-1) and mixtures thereof. Particularly preferred QUATS are the benzalkonium chlorides containing C₈₋₁₈ alkyl groups, more particularly C₁₂-C₁₄ alkylbenzyldimethylammonium chloride.

Benzalkonium halides and/or substituted benzalkonium halides are commercially available, for example, as Barquat® from Lonza, Marquato® from Mason, Variquat® from Witco/Sherex and Hyamine® from Lonza and as Bardac® from Lonza. Other commercially obtainable antimicrobial agents are N-(3-chloroallyl)-hexaminium chloride, such as Dowicide® and Dowicil® from Dow, benzethonium chloride, such as Hyamine® 1622 from Rohm & Haas, methyl benzethonium chloride, such as Hyamine® 10× from Rohm & Haas, cetyl pyridinium chloride, such as cepacolchloride from Merrell Labs.

The antimicrobial agents are used in quantities of 0.0001% by weight to 1% by weight, preferably 0.001% by weight to 0.8% by weight, particularly preferably 0.005% by weight to 0.3% by weight and most preferably 0.01 to 0.2% by weight.

The inventive laundry detergents or cleaning compositions may comprise UV absorbers that attach to the treated textiles and improve the light stability of the fibers and/or the light stability of the various ingredients of the formulation. UV-absorbers are understood to mean organic compounds, which are able to absorb UV radiation and emit the resulting energy in the form of longer wavelength radiation, for example as heat.

Compounds, which possess these desired properties, are for example, the efficient radiationless deactivating compounds and derivatives of benzophenone having substituents in position(s) 2- and/or 4. Also suitable are substituted benzotriazoles, acrylates, which are phenyl-substituted in position 3 (cinnamic acid derivatives optionally with cyano groups in position 2), salicylates, organic Ni complexes, as well as natural substances such as umbelliferone and the endogenous urocanic acid. The biphenyl and above all the stilbene derivatives such as for example those described in EP 0 728 749 A and commercially available as Tinosorb® FD or Tinosorb® FR from Ciba, are of particular importance. As UV-B absorbers can be cited: 3-benzylidenecamphor or 3-benzylidenenorcamphor and its derivatives, for example 3-(4-methylbenzylidene) camphor, as described in the EP 0693471 B1; 4-aminobenzoic acid derivatives, preferably 4-(dimethylamino)benzoic acid, 2-ethylhexyl ester, 4-(dimethylamino)benzoic acid, 2-octyl ester and 4-(dimethylamino)benzoic acid, amyl ester; esters of cinnamic acid, preferably 4-methoxycinnamic acid, 2-ethylhexyl ester, 4-methoxycinnamic acid, propyl ester, 4-methoxycinnamic acid, isoamyl ester, 2-cyano-3,3-phenylcinnamic acid, 2-ethylhexyl ester (octocrylene); esters of salicylic acid, preferably salicylic acid, 2-ethylhexyl ester, salicylic acid, 4-isopropylbenzyl ester, salicylic acid, homomethyl ester; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzmalonic acid, di-2-ethylhexylester; triazine derivatives, such as, for example 2,4,6-trianilino-(p-carbo-2′-ethyl-1′-hexyloxy)-1,3,5-triazine and octyl triazone, as described in EP 0818450 A1 or dioctyl butamidotriazone (Uvasorb® HEB); propane-1,3-dione, such as for example 1-(4-tert.-butylphenyl)-3-(4′-methoxyphenyl)propane-1,3-dione; ketotricyclo(5.2.1.0) decane derivatives, as described in EP 0694521 B1. Further suitable are 2-phenylbenzimidazole-5-sulfonic acid and its alkali-, alkaline earth-, ammonium-, alkylammonium-, alkanolammonium- and giucammonium salts; sulfonic acid derivatives of benzophenones, preferably 2-hydroxy-4-methoxybenzophenone-5-sulfonic acid and its salts; sulfonic acid derivatives of 3-benzylidenecamphor, as for example 4-(2-oxo-3-bornylidenemethyl)benzene sulfonic acid and 2-methyl-5-(2-oxo-3-bornylidene)sulfonic acid and its salts.

Typical UV-A filters particularly include derivatives of benzoylmethane, such as, for example 1-(4′-tert.-butylphenyl)-3-(4′-methoxyphenyl)propane-1,3-dione, 4-tert.-butyl-4′-methoxydibenzoylmethane (Parsol 1789), 1-phenyl-3-(4′-isopropylphenyl)-propane-1,3-dione as well as enamine compounds, as described in DE 19712033 A1 (BASF). Naturally, the UV-A and UV-B filters can also be added as mixtures. Beside the cited soluble materials, insoluble, light protective pigments, namely finely dispersed, preferably, nano metal oxides or salts can also be considered for this task. Exemplary suitable metal oxides are particularly zinc oxide and titanium oxide and also oxides of iron, zirconium, silicon, manganese, aluminum and cerium as well as their mixtures. Silicates (talc), barium sulfate or zinc stearate can be added as salts. The oxides and salts are already used in the form of pigments for skin care and skin protecting emulsions and decorative cosmetics. Here, the particles should have a mean diameter of less than 100 nm, preferably between 5 and 50 nm and especially between 15 and 30 nm. They can be spherical, however elliptical or other non-spherical shaped particles can also be used. The pigments can also be surface treated, i.e., hydrophilized or hydrophobized. Typical examples are coated titanium dioxides, such as, for example Titandioxid Z 805 (Degussa) or Eusolex® T2000 (Merck); preferably, silicones and particularly preferably trialkoxy octylsilanes or Simethicones are used as the hydrophobic coating agents Preferably, micronized zinc oxide is used. Further suitable UV light protection filters may be found in the review by P. Finkel in SöFW-Journal, Volume 122 (543), p. 1996.

The UV absorbers are normally used in amounts of 0.01 wt. % to 5 wt. %, preferably from 0.03 wt. % to 1 wt. %.

To increase their washing or cleaning power, agents according to the invention can comprise enzymes, wherein in principle, any enzyme established for these purposes in the prior art may be used. These particularly include proteases, amylases, lipases, hemicellulases, cellulases or oxidoreductases as well as preferably their mixtures. In principle, these enzymes are of natural origin; improved variants based on the natural molecules are available for use in detergents and accordingly they are preferred. The agents according to the invention preferably comprise enzymes in total quantities of 1×10⁻⁶ to 5 weight percent based on active protein.

Preferred proteases are those of the subtilisin type. Examples of these are subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisines thermitase, proteinase K and the proteases TW3 und TW7. Subtilisin Carlsberg in further developed form is available under the trade name Alcalase® from Novozymes A/S, Bagsvaerd, Denmark. Subtilisins 147 and 309 are commercialized under the trade names Esperase® and Savinase® by the Novozymes company. Variants derived from the protease from Bacillus lentus DSM 5483 (WO 91/02792 A1) called BLAP® are described especially in WO 92/21760 A1, WO 95/23221 A1, WO 02/088340 A2 and WO 03/038082 A2. Further useable proteases from various Bacillus sp. and B. gibsonii strains emerge from the patent applications WO 03/054185 A1, WO 03/056017 A2, WO 03/055974, WO 03/054184 A1, DE 102006022216 and DE 102006022224.

Further useable proteases are, for example, those enzymes available under the trade names Durazym®, Relase®, Everlase®, Nafizym, Natalase®, Kannase® and Ovozymes® from the Novozymes Company, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of further useable amylases according to the invention are the α-amylases from Bacillus licheniformis, from B. amyloliquefaciens and from B. stearothermophilus, as well as their improved further developments for use in laundry detergents and cleaning compositions. The enzyme from B. licheniformis is available from the Novozymes Company under the name Termamyl® and from the Genencor Company under the name Purastar®ST. Further development products of this α-amylase are available from the Novozymes Company under the trade names Duramyl® and Termamyl® ultra, from the Genencor Company under the name Purastar® OxAm and from Daiwa Seiko Inc., Tokyo, Japan as Keistase®. The α-amylase from B. amyloliquefaciens is commercialised by the Novozymes Company under the name BAN®, and derived variants from the α-amylase from B. stearothermophilus under the names BSG® and Novamyl® also from the Novozymes Company. Additional commercial products that can be used are for example the Amylase-LT® and Stainzyme Ultra®, the latter also from the Novozymes company.

Moreover, for these purposes, attention should be drawn to the α-amylase from Bacillus sp. A 7-7 (DSM 12368) disclosed in the application WO 02/10356 A2 and the cyclodextrin-glucanotransferase (CGTase) from B. agaradherens (DSM 9948) described in the application WO 02/44350 A2. Furthermore, the amylolytic enzymes are useable, which belong to the sequence space of α-amylase, described in the application WO 03/002711 A2 and those described in the application WO 03/054177 A2. Similarly, fusion products of the cited molecules are applicable, for example those from the application DE 10138753 A1.

Moreover, further developments of α-amylase from Aspergillus niger und A. oryzae available from the Company Novozymes under the trade name Fungamyl® are suitable. A further commercial product is the amylase-LT® for example.

The agents according to the invention can comprise lipases or cutinases, particularly due to their triglyceride cleaving activities, but also in order to produce in situ peracids from suitable preliminary steps. These include for example the available or further developed lipases originating from Humicola lanuginosa (Thermomyces lanuginosus), particularly those with the amino acid substitution D96L. They are commercialized, for example by the Novozymes Company under the trade names Lipolase®, Lipolase® Ultra, LipoPrime®, Lipozyme® and Lipex®. Moreover, suitable cutinases, for example are those that were originally isolated from Fusarium solani pisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina and Fusarium solanii are for example available from the Genencor Company. Further important commercial products that may be mentioned are the commercial preparations M1 Lipase® and Lipomax® originally from Gist-Brocades Company, and the commercial enzymes from the Meito Sangyo KK Company, Japan under the names Lipase MY-30®, Lipase OF® and Lipase PL® as well as the product Lumafast® from the Genencor Company.

Compositions according to the invention, particularly when they are destined for treating textiles, can comprise cellulases, according to their purpose, as pure enzymes, as enzyme preparations, or in the form of mixtures in which the individual components advantageously complement their various performances. Among these aspects of performance are particular contributions to primary washing performance, to secondary washing performance of the product, (anti-redeposition activity or inhibition of graying) and softening or brightening (effect on the textile), through to practicing a “stone washed” effect.

A usable, fungal endoglucanase(EG)-rich cellulase preparation, or its further developments are offered by the Novozymes Company under the trade name Celluzyme®. The products Endolase® and Carezyme® based on the 50 kD-EG, respectively 43 kD-EG from H. insolens DSM 1800 are aiso obtainable from Novozymes Company. The latter is based on the application WO 96/29397 A1. Performance enhanced cellulase variants emerge from the application WO 98/12307 A1, for example. It is equally possible to use the cellulases disclosed in the application WO 97/14804 A1; for example the 20 kD EG disclosed therein from Melanocarpus, and which is available under the trade names Ecostone® and Biotouch® from AB Enzymes, Finland. Further commercial products from the AB Enzymes Company are Econase® and Ecopulp®. Further suitable cellulases from Bacillus sp. CBS 670.93 and CBS 669.93 are disclosed in WO 96/34092 A2, the CBS 670.93 from Bacillus sp. being obtainable under the trade name Puradax® from the Genencor Company. Other commercial products from the Genencor Company are “Genencor detergent cellulase L” and Indiage® Neutra.

The compositions according to the invention can comprise additional enzymes especially for removing specific problem stains and which are summarized under the term hemicellulases. These include, for example mannanases, xanthanlyases, pectinlyases (=pectinases), pectinesterases, pectatlyases, xyloglucanases (=xylanases), pullulanases und β-glucanases. Suitable mannanases, for example are available under the names Gamanase® and Pektinex AR® from Novozymes Company, under the names Rohapec® B1 from AB Enzymes and under the names Pyrolase® from Diversa Corp., San Diego, Calif., USA. A suitable β-Glucanase from a B. alcalophilus emerges from the application WO 99/06573 A1, for example. β-Glucanase extracted from B. subtilis is available under the name Cereflo® from Novozymes Company.

Inventive laundry detergents and cleaning compositions can also comprise hydrogen peroxide-producing oxidoreductases in order to increase the bleaching effect. The hydrogen peroxide-producing oxidoreductases here concern an oxidoreductase that produces hydrogen peroxide, in that it uses oxygen as an electron acceptor. In this regard, oxidoreductases of the EC classes EC 1.1.3 (CH—OH as electron donor), EC 1.2.3 (aldehyde or oxo groups as electron donor), EC 1.4.3 (CH—NH₂ as donor), EC 1.7.3 (N-containing groups as donor) and EC 1.8.3 (S-containing groups as donor) are suitable, wherein enzymes of the EC class EC 1.1.3 are preferred. Preferred enzymes are especially selected from the group consisting of malate-oxidase (EC 1.1.3.3), glucose-oxidase (EC 1.1.3.4), hexose-oxidase (EC 1.1.3.5), cholesterol-oxidase (EC 1.1.3.6), galactose-oxidase (EC 1.1.3.9), pyranose-oxidase (EC 1.1.3.10), alcohol-oxidase (EC 1.1.3.13), choline-oxidase (EC 1.1.3.17, see in particular WO 04/58955), oxidases for long chain alcohols (EC 1.1.3.20), glycerine-3-phosphate-oxidase (EC 1.1.3.21), cellobiose-oxidase (EC 1.1.3.25), nucleoside-oxidase (EC 1.1.3.39), D-mannitol-oxidase (EC 1.1.3.40), xylitol-oxidase (EC 1.1.3.41), aldehyde-oxidase (EC 1.2.3.1), pyruvate-oxidase (EC 1.2.3.3), oxalate-oxidase (EC 1.2.3.4), glyoxylate-oxidase (EC 1.2.3.5), indole-3-acetaldehyde-oxidase (EC 1.2.3.7), pyridoxal-oxidase (EC 1.2.3.8), arylaldehyde-oxidase (EC 1.2.3.9), retinal-oxidase (EC 1.2.3.11), L-amino acid-oxidase (EC 1.4.3.2), amine-oxidase (EC 1.4.3.4, EC 1.4.3.6), L-glutamate-oxidase (EC 1.4.3.11), L-lysine-oxidase (EC 1.4.3.14), L-aspartate-oxidase (EC 1.4.3.16), tryptophan-α,β-oxidase (EC 1.4.3.17), glycine-oxidase EC 1.4.3.19), urea-oxidase (EC 1.7.3.3), thiol-oxidase (EC 1.8.3.2) and glutathione-oxidase (EC 1.8.3.3). For the hydrogen peroxide-producing oxidoreductases, in a preferred embodiment, they concern one that uses a sugar as the electron donor. The hydrogen peroxide-producing oxidoreductase and sugar oxidizing oxidoreductase is preferably inventively selected from glucose-oxidase (EC 1.1.3.4), hexose-oxidase (EC 1.1.3.5), galactose-oxidase (EC 1.1.3.9) and pyranose-oxidase (EC 1.1.3.10). According to the invention, the glucose-oxidase (EC 1.1.3.4) is particularly preferred. Advantageously, additional, preferably organic, particularly preferably aromatic compounds are added that interact with the enzymes to enhance the activity of the oxidoreductases in question or to facilitate the electron flow (mediators) between the oxidizing enzymes and the stains over strongly different redox potentials.

In addition to the hydrogen peroxide-producing oxidoreductases, the inventive compositions can also comprise additional oxidoreductases, in particular oxidases, oxygenases, laccases (phenoloxidase, polyphenoloxidases) and/or dioxygenases. As suitable commercial products for laccases may be cited Denilite® 1 and 2 from the Novozymes Company. In a preferred embodiment, the additional oxidoreductases is selected from: enzymes that use peroxides as the electron accepter (EC-Classes 1.11 or 1.11.1), in particular from catalases (EC 1.11.1.6), peroxidases (EC 1.11.1.7), glutathioneperoxidases (EC 1.11.1.9), chlorideperoxidases (EC 1.11.1.10), manganeseperoxidases (EC 1.11.1.13) and/or ligninperoxidases (EC 1.11.1.14), which in general can also be classified as peroxidases. Perhydrolases can also be used instead of or in addition to these peroxidases. Perhydrolases, which in earlier times were also called metal-free haloperoxidases, generally comprise the catalytic triad Ser-His-Asp in the reaction center and catalyze the reversible formation of peroxy acids starting from carboxylic acids and hydrogen peroxide. In regard to inventively suitable perhydrolases, reference is particularly made to the applications WO 98/45398, WO 04/58961, WO 05/56782 and PCT/EP05/06178. When perhydrolases are employed, carboxylic acids, their salts and/or their esters and/or derivatives thereof are correspondingly comprised in the inventive compositions.

The enzymes used in the agents according to the invention either stem originally from microorganisms, such as the species Bacillus, Streptomyces, Humicola, or Pseudomonas, and/or are produced according to known biotechnological processes using suitable microorganisms such as by transgenic expression hosts of the species Bacillus or filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

The enzymes can be added to the inventive agents in each established form according to the prior art. Included here, for example, are solid preparations obtained by granulation, extrusion or lyophilization, or particularly for liquid compositions or compositions in the form of gels, enzyme solutions, advantageously highly concentrated, of low moisture content and/or mixed with stabilizers. Alternatively, these proteins, both for the solid as well as the liquid presentation forms, can be adsorbed on a solid carrier and/or encapsulated.

Encapsulation can be carried out for example by spray drying or extrusion of the enzyme solution together with a preferably natural polymer or for example in the form of capsules, in which the enzymes are embedded as in a solidified gel, or in those of the core-shell type, in which an enzyme-containing core is covered with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluidized bed processes. Advantageously, these types of granulates, for example with an applied polymeric film former are dust-free and as a result of the coating are storage stable.

The encapsulated form is a way of protecting the enzymes or other ingredients against other components such as, for example, bleaching agents, or of making possible a controlled release. Depending on their size, said capsules are divided into milli-, micro- and nanocapsules, microcapsules being particularly preferred for enzymes. Such capsules are disclosed, for example, in the Patent applications WO 97/24177 and DE 199 18 267.

Another possible encapsulation method is to encapsulate the proteins, starting from a mixture of the protein solution with a solution or suspension of starch or a starch derivative, in this substance. Such an encapsulation process is described in the application WO 01/38471.

In a particular embodiment, the enzymes can also be granulated, as is described in the application DE 102006018780. In addition to the enzymes, other sensitive ingredients of laundry detergents or cleaning compositions can also be granulated in this way, such as for example fragrances, optical brighteners or bleach activators, so as to protect them against other components, especially against the optionally present bleaching agents.

In this embodiment, the sensitive ingredient of laundry detergents or cleaning compositions is granulated with a chemically inert carrier material and a chemically inert binder. In this regard, the carrier material can be selected from inorganic substances, such as for example clays, silicates or sulfates, especially talcum, silicas, metal oxides, especially aluminum oxides and/or titanium dioxide, silicates, especially layered silicates, sodium aluminum silicates, Bentonites and/or alumosilicates (zeolites). They can also be organic compounds such as for example polyvinyl alcohol (PVA), in particular an at least partially hydrolyzed PVA. It is particularly advantageous when these compounds fulfil an additional use, for example a builder function when added to the laundry detergent or cleaning composition.

In this embodiment, however, a binder is understood to mean a room temperature-solid, pasty (waxy) or liquid material that is likewise chemically so inert that under the conditions of manufacture, processing and storage of the granulate, it reacts with none of the other ingredients of the granulate or the composition to any degree that impairs the overall activity of the granulate. It is a different material than the carrier material. Under the conditions of granulate manufacture it is or at least becomes so viscous that it virtually glues the other ingredients together. In this respect, the physiochemical interaction with the carrier material is particularly important, as this enables the resulting mass to become a completely homogeneous phase that can be subsequently converted into individual granulate particles. This mash that is formed predominantly from the carrier material components and the binder components, entraps the other ingredients and especially the ingredient to be conditioned. Suitable binders are inorganic or organic substances that have the described properties, for example uncrosslinked, polymeric compounds selected from the group of the polyacrylates, polymethacrylates, methacrylic acid-ethyl acrylate copolymers, polyvinyl pyrrolidones, polysaccharides or substituted polysaccharides, in particular cellulose ethers, and/or polyvinyl alcohols (PVA), preferably partially hydrolyzed polyvinyl alcohols and/or ethoxylated polyvinyl alcohols as well as their copolymers and mixtures. Due to their adsorption properties and their concomitant binding action, PVA or its derivatives are suitable both as carrier materials as well as components of the binder. Consequently, they can be employed as the binder if they are not already employed as the carrier material.

For the rest, reference is made to DE 102006018780 in regard to this embodiment.

In addition, it is possible to formulate two or more enzymes together, so that a single granulate exhibits a plurality of enzymatic activities.

A protein comprised in an inventive composition can be protected, particularly in storage, against deterioration such as, for example inactivation, denaturation or decomposition, for example through physical influences, oxidation or proteolytic cleavage. An inhibition of the proteolysis is particularly preferred during microbial preparation of proteins and/or enzymes, particularly when the compositions also contain proteases. Preferred compositions according to the invention comprise stabilizers for this purpose.

One group of stabilizers is the reversible protease inhibitors. For this, benzamidine hydrochloride, borax, boric acids, boronic acids or their salts or esters are frequently used, above all derivatives with aromatic groups, for example ortho, meta or para substituted phenyl boronic acids, particularly 4-formylphenyl boronic acid or the salts or esters of the cited compounds. Peptide aldehydes, i.e., oligopeptides with a reduced C-terminus, particularly those from 2 to 50 monomers, are also used for this purpose. Ovomucoid and leupeptin, among others, belong to the peptidic reversible protease inhibitors. Specific, reversible peptide inhibitors for the protease subtilisin and fusion proteins from proteases and specific peptide inhibitors are also suitable.

Further enzyme stabilizers are amino alcohols such as mono-, di-, triethanol- and -propanolamine and their mixtures, aliphatic carboxylic acids up to C₁₂, such as, for example succinic acid, other dicarboxylic acids or salts of the cited acids. End-capped fatty acid amide alkoxylates are also suitable for this purpose. Certain organic acids used as builders can additionally stabilize an included enzyme.

Lower aliphatic alcohols, but above all polyols such as, for example glycerine, ethylene glycol, propylene glycol or sorbitol, are other frequently used enzyme stabilizers. Di-glycerol phosphate also protects against denaturation by physical influences. Similarly, calcium and/or magnesium salts are used, such as, for example calcium acetate or calcium formate.

Polyamide oligomers or polymeric compounds such as lignin, water-soluble vinyl copolymers or cellulose ethers, acrylic polymers and/or polyamides stabilize the enzyme preparations inter alia against physical influences or pH variations. Polymers containing polyamine-N-oxide act simultaneously as enzyme stabilizers and as color transfer inhibitors. Other polymeric stabilizers are linear C₈-C₁₈ polyoxyalkylenes. Alkyl polyglycosides can also stabilize the enzymatic components of the inventive composition and are additionally capable of advantageously increasing their performance. Crosslinked nitrogen-containing compounds preferably perform a dual function as soil release agents and as enzyme stabilizers. A hydrophobic, non-ionic polymer stabilizes in particular an optionally present cellulase.

Reducing agents and antioxidants increase the stability of enzymes against oxidative decomposition; sulfur-containing reducing agents are commonly used here. Other examples are sodium sulfite and reducing sugars.

The use of combinations of stabilizers is particularly preferred, for example of polyols, boric acid and/or borax, the combination of boric acid or borate, reducing salts and succinic acid or other dicarboxylic acids or the combination of boric acid or borate with polyols or polyamino compounds and with reducing salts. The effect of peptide-aldehyde stabilizers is conveniently increased by the combination with boric acid and/or boric acid derivatives and polyols and even more by the additional effect of divalent cations, such as for example calcium ions.

In the case of solid compositions, the proteins may be used, for example, in dried, granulated and/or encapsulated form. They can be added separately, i.e., as one phase, or together with other ingredients in the same phase, with or without compaction. If microencapsulated, solid enzymes are used, then the water can be removed from the aqueous solutions resulting from the process by means of processes known from the prior art, such as spray-drying, centrifugation or by trans-dissolution. The particles obtained in this manner usually have a particle size between 50 and 200 μm.

Starting from protein recovery carried out according to the prior art, and preparation in a concentrated aqueous or non-aqueous solution, suspension or emulsion, but also in gel form or encapsulated or as a dried powder, the proteins can be added to liquid, gelled or pasty compositions of the invention. Such laundry detergents or cleaning compositions of the invention are usually prepared by simply mixing the ingredients which may be introduced as solids or as solution into an automated mixer.

The content of the enzymes, liquid enzyme formulation(s) or the enzyme granules in a laundry detergent or cleaning composition can be, for example, about 0.01 to 5% by weight and is preferably 0.12 to about 2.5% by weight.

An inventive cleaning composition, in particular an inventive cleaner for hard surfaces, can also comprise one or more propellants, usually in an amount of 1 to 80 wt. %, preferably 1.5 to 30 wt. %, particularly 2 to 10 wt. %, particularly preferably 2.5 to 8 wt. %, above all 3 to 6 wt. %.

Propellants, according to the invention, are usually propellant gases, particularly liquefied or compressed gases. The choice depends on the product to be sprayed and the field of application. When using compressed gases such as nitrogen, carbon dioxide or nitrous oxide, which are generally insoluble in the liquid cleaning composition, the operating pressure is reduced each time the valve is actuated. Liquefied gases that are soluble in, or that themselves act as solvents for the cleaning composition, offer as propellants the advantage of a constant operating pressure and uniform dispersion, because the propellant evaporates in air and thereby expands several hundred times in volume.

Accordingly, the following are suitable propellants (names according to INCI): Butane, Carbon Dioxide, Dimethyl Carbonate, Dimethyl Ether. Ethane, Hydrochlorofluorocarbon 22, Hydrochlorofluorocarbon 142b, Hydrofluorocarbon 152a, Hydrofluorocarbon 134a, Hydrofluorocarbon 227ea, Isobutane, Isopentane, Nitrogen, Nitrous Oxide, Pentane, Propane. However, the use of chlorofluorocarbons (CFC) as propellants is preferably widely avoided and especially totally avoided due to their harmful effect on the ozone layer of the atmosphere that protects against harmful UV radiation.

Preferred propellants are liquefied gases. Liquid gases are gases that can be transformed from the gaseous into the liquid state at mostly already low pressures and 20° C. However liquid gases are particularly understood to be the hydrocarbons propane, propene, butane, butene, isobutane (2-methylpropane), isobutene (2-methylpropene, isobutylene) and their mixtures, which occur as by products from distilling and cracking oil in oil refineries as well as in natural gas processing in gasoline separation.

The cleaning composition particularly preferably comprises one or a plurality of propellants selected from propane, butane and/or isobutane, especially propane and butane, most preferably propane, butane and isobutane.

In a preferred embodiment, the composition containing an inventive hyper-branched polymer is designed in such a way that it can be used regularly as a conditioner, for example by adding it to the washing process, using it after washing or applying it independently of the washing. The desired effect consists in the prevention and/or the reduction of the growth and/or the adhesion of microorganisms.

Processes for the automatic cleaning of textiles or hard surfaces constitute an independent subject of the invention, in which an inventive hyper-branched polymer is used in at least one of the process steps.

These processes include both manual as well as automatic processes, automatic processes being preferred due to their more precise controllability that concerns for example the added quantities and contact times.

Processes for the cleaning of textiles are generally characterized in that various cleaning-active substances are applied to the material to be cleaned in a plurality of process steps and, after the contact time, are washed away, or that the material to be cleaned is treated in any other way with a detergent or a solution of this detergent. The same applies to methods for cleaning any materials other than textiles, which are classified by the term hard surfaces. It is possible to add inventive hyper-branched polymers to at least one of the process steps of all conceivable washing or cleaning processes; accordingly, these processes then illustrate embodiments of the present invention.

Another subject matter of the present invention is also a product comprising an inventive composition or an inventive laundry detergent or cleaning composition, in particular an inventive cleaner for hard surfaces, and a spray dispenser. In this regard, the product can be either a single chamber container as well as a multi-chamber container, in particular a two-chamber container. The preferred spray dispenser is a manually operated spray dispenser, selected in particular from the group including aerosol spray dispensers (pressurized gas containers; also known inter alia as spray cans), self generated pressure spray dispensers, pump spray dispensers and trigger spray dispensers, particularly pump spray dispensers and trigger spray dispensers with a container made of transparent polyethylene or polyethylene terephthalate. Spray dispensers are extensively described in WO 96/04940 (Proctor & Gamble) and in the US patents cited therein concerning spray dispensers, all of which are referred to in this respect and their content is hereby incorporated in this application. Trigger spray dispensers and pump spray dispensers are advantageous in comparison with pressurized gas containers as no propellant need be employed. By means of attachments suitable for particles, (“nozzle-valves”) on the spray dispenser, the enzyme in this embodiment can also be optionally added in the form of immobilized particles to the composition and can thus be dosed as the cleaning foam.

The following examples further exemplify the present invention without limiting it in any way.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

The following Examples further illustrate the preferred embodiments within the scope of the present invention, but are not intended to be limiting thereof. It is understood that the examples and embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

### EXAMPLES

### Example 1

### Synthesis of Hyper-Branched Block Copolymers

In a 1 liter Buchi glass reactor were placed 250 ml THF (tetrahydrofuran) and 0.92 ml (5.84×10⁻³ mol) 1,3-diisopropenylbenzene and maintained at 30° C. Under vigorous stirring at this temperature, was then added by syringe an equimolar quantity of butyllithium (4.39 ml; 5.84×10⁻³ mol). A green coloration was observed. After a reaction time of 15 minutes, the reactor was cooled down to −30° C. After 30 minutes, 0.9 ml (8.69×10⁻³ mol) styrene was added by syringe to these living crosslinked cores. The color changed to orange and then back to green. After a reaction time of ca. 4 hours at −30° C. were added 9.3 ml (0.08 mol) 4-vinylpyridine. The color again changed from green to yellow to colorless. After a reaction period of 16 hours, the reaction was terminated by adding 10 ml of degassed methanol. The polymer solution was worked up by concentration in the rotary evaporator (to about ¼ of the volume) and then precipitation in ether. The precipitated polymer could be centrifuged out. In a second step the synthesized hyper-branched block copolymer (1 g) was alkylated in chloroform with 2 ml methyl iodide at room temperature for 8 hours. The yellow polymer was worked up by precipitation in diethyl ether and centrifugation.

### Analysis of the Polymer

The ratio of styrene to 4-vinylpyridine was determined by ¹H-NMR as 1:10. This result corresponds exactly to the intended value. The synthesized hyper-branched block copolymer was calibrated by DMF-GPC. A molecular weight M_{w}=57000 g/mol and a poly-dispersity of M_{w}/Mₙ=0.71 were determined. The DMF-GPC was calibrated with a PS calibration standard.

### Application

In order to be able to antimicrobially coat a surface, a 1% conc. clear colorless aqueous solution of the alkylated hyper-branched block copolymer was prepared. A volume of 80 μl of this solution was deposited on a glass surface of 1 in² and dispersed. Evaporation of the solvent afforded a clear homogeneous film.

### Example 2

### Antimicrobial Spray Test with Staphylococcus aureus

For this bacterial test, S. aureus cells were incubated in a standard nutrient medium from Merck (2.5 wt. %) for 6 hours with shaking at 37° C. (injected with 100 μl storage suspension in PBS (1010 cells/ml) in 50 ml nutrient medium). After centrifugation at 2750 rpm for 10 min, the cells were suspended in dist. water at a concentration of 10⁶ cells per milliliter. This suspension was sprayed onto a coated glass or ceramic slide and overlaid with liquid nutrient agar. After an incubation period of ca. 16 hours at 37° C., the resulting colonies were dyed red with a dye solution (5 mg/ml TTC) on the non-antimicrobially affected regions. It was observed that no colony formation occurred in the sprayed area of the slide, i.e., the growth of Staphylococcus aureus was inhibited.

Table 1 shows a selection of antimicrobial hyper-branched polymers that as the coating demonstrated antimicrobial properties.

TABLE 1
Results of the antimicrobial spray test

| Methylated polymer | Ratio styrene:4-vinylpyridine | Bacterial spray test |
|---|---|---|
| AF 148 | 1:10 | + |
| AF 248 | 1:3.7 | + |
| AF 249 | 1:19.6 | + |
| AF 152 | 1:4 | + |
| AF 252 | 1:3.2 | + |
| AF 253 | 1:10.8 | + |

TABLE 2
Results of the antimicrobial spray test and on the solubility

| Synthesized | Methylated | Crosslinker: | Styrene:4-VP | Solubility | | |
|---|---|---|---|---|---|---|
| Block copolymer | polymer | Styrene | (¹H-NMR) | Water | DMSO | Antimikrobial |
| AF244 | AF248 | 1:25 | 1:3.7 | + | + | + |
| AF245 | AF249 | 1:25 | 1:19.6 | + | + | + |
| AF250 | AF252 | 1:50 | 1:3.2 | + | + | + |
| AF251 | AF253 | 1:50 | 1:10.8 | + | + | + |
| AF221 | AF222 | 1:25 | 1:3.9 | + | + | + |
| AF230 | AF254 | 1:25 | 1:6.1 | + | + | + |
| AF242 | AF246 | 1:50 | 1:4.2 | + | + | + |
| AF243 | AF247 | 1:50 | 1:8.2 | + | + | + |
| AF284 | AF285 | 1:25 | 1:24 | + | + | + |
| AF286 | AF287 | 1:25 | 1:24 | + | + | + |
| AF288 | AF289 | 1:25 | 1:24 | + | + | + |

### Example 3

### Microbiological Analyses Pursuant to JIS Z 2801:2000

The “Film Contact Method” pursuant to the Japanese Industrial Standard JIS Z 2801:2000 was used for the quantitative evaluation of the biostatic and biocidal properties. Polymers AF 148 and AF 152 were used. The polymers were dissolved in 10% conc. ethanol and applied onto Petri dishes and dried.

A germ suspension with a defined germ density was then deposited onto the coated test specimens and evenly dispersed on them by means of a cover glass. An uncoated Petri dish was used as the control. For testing the microbiological efficacy, the gram-positive Staphylococcus aureus was used as the test germ. After a defined incubation period, here 0 and 24 hours, the test specimens were shaken with the deposited germ suspension and a dilution series prepared for the determination of the germ count. The proof of the biocidal action results from the determination of colony forming units (CFU) in comparison with the untreated control.

TABLE 3
Results of the microbiological analyses

| | | | Survival rate per |
|---|---|---|---|
| | Concentration | Inubation time | test sample |
| Test sample | [wt. %] | [h] | [CFU] |
| Control | — | 0 | 2.59 × 10⁵ |
| Control | — | 24 | 2.43 × 10⁶ |
| AF 148 | 1 | 24 | 2.05 × 10¹ |
| AF 148 | 5 | 24 | 1.36 × 10¹ |
| AF 152 | 1 | 24 | <5 × 10¹ |
| AF 152 | 5 | 24 | <5 × 10¹ |

It can be seen that the survival rates of Staphylococcus aureus were lowered by at least 4 or 5 powers of ten by the hyper-branched polymers.

### Example 4

### Experimental Procedure for the Storage Tests

In order to test the dye absorption capacity, a stock solution of the dye oil red in acetone was prepared. Ten different defined quantities of this solution were pipetted into snap-on cap jars and the solvent was completely removed. 1 ml of a 1% conc. aqueous polymer solution of AF 249 (3 stars with styrene/4-vinylpyridine ratio of 1:19.6) was then added to each tube.

The 10 snap-on cap jars were treated with ultra sound for 24 hours. The liquid from the snap-on cap jars was then transferred into Eppendorf microtubes and centrifuged (2 minutes, 10,000 rpm) in an ultracentrifuger. This ensured that any absorbed insoluble dye components do not interfere in the subsequent UVNIS measurement. In the subsequent UVNIS measurement, the absorption was compared at 518 nm and plotted against the starting concentration of the dye. It showed that the dye absorption initially increases linearly and reaches saturation above a certain concentration. In order to quantify the absorption capacity, the centrifugate of both the last samples was taken up in acetone. From this solution the residual quantity of undissolved dye was determined by absorption. The absorbed quantity of dye (2.69×10⁻⁰⁷mol) is the difference between the initial weight (2.84×10⁻⁰⁷ mol) and the determined quantity of residual dye (1.44×10⁻⁰⁸ mol). For a molecular weight of 85,000 g/mol, this corresponds to an average of 2.28 dye molecules per hyper-branched polymer.

### Example 5

### Test of Storage Stability at 50° C.

The storage stability of the polymer product mixture was carried out at 50° C. for a period of 74 days. Three different preparations were tested:
0% commercial WC-cleaner; 1 wt. % AF 249 in water
10% commercial WC-cleaner; 1 wt. % AF 249 in water
100% commercial WC-cleaner; 1 wt. % AF 249

The clear yellowish solutions were stored for 74 days at a temperature of 50° C. No difference to the starting samples could be seen after this storage period. Neither discoloration nor turbidity could be observed. To check whether the antimicrobial activity of the solution was still present after this time, 70 μl of the different solutions were removed and coated on a surface of 1 in² on a glass slide. The film was subjected to an antimicrobial spray test with Staphylococcus aureus. It was clearly evident that the growth of S. aureus was inhibited on all three coatings. Therefore, the antimicrobial activity is not limited by a long-term storage at 50° C.

### Example 6

### Test of Storage Stability after Three Defrosting Cycles

In another test, various polymer-product mixtures were frozen three times at −20° C. for three days and defrosted again. The three different preparations were as in the tests at 50° C.:
0% commercial WC-cleaner; 1 wt. % AF 249 in water
10% commercial WC-cleaner; 1 wt. % AF 249 in water
100% commercial WC-cleaner; 1 wt. % AF 249

No difference to the starting frozen samples could be observed after the three cycles. Neither discoloration nor turbidity could be observed. The antimicrobial activity was tested as in the case of the long-term storage test at 50° C. with S. aureus. It was clearly evident that the growth of S. aureus was inhibited on all three areas coated with the polymer/product solution. Therefore, the antimicrobial activity is not limited by the freeze-thaw cycles used.

### Figure

In FIG. 1 are presented the results of the antimicrobial tests of AF 249 on ceramic (tiles). The adhesion of Staphylococcus aureus was investigated. The adhesion values of the untreated tile (0 hours) as well as the 16 hour and 24 hour values, each from left to right, are presented after treatment pursuant to the film contact method. On the left for comparison is illustrated the adhesion on a) an untreated plastic surface, beside b) the adhesion on an untreated tile. Next to them from left to right are illustrated the adhesion of tiles that were treated with c) 100% of a commercial WC-cleaner, d) 100% of a commercial WC-cleaner plus 2 wt. % AF 249, e) 10% of a commercial WC-cleaner and d) 10% of a commercial WC-cleaner plus 2 wt. % AF 249.

What is claimed is:

1. A hyper-branched polymer comprising a hydrophobic core and an antimicrobially and/or anti-adhesively active shell.

2. A hyper-branched polymer according to claim 1, wherein the hydrophobic core is comprised of silicone groups or a hydrophobic hydrocarbon that can optionally also comprise one or more heteroatoms.

3. A hyper-branched polymer according to claim 1, wherein the hydrophobic core is comprised of a hydrophobic hydrocarbon comprising one or more aromatic C₆₋₁₀ aryl groups.

4. A hyper-branched polymer according to claim 1, wherein the hydrophobic core is comprised of a hyper-branched core, onto which a plurality of branches is linked, each branch comprising a hydrophobic region, onto which, from inside to outside, an antimicrobially and/or anti-adhesively active region is attached.

5. A hyper-branched polymer according to claim 4, wherein the hydrophobic region in each branch comprises a polymer unit of at least 10 monomers arranged in a block, wherein each monomer comprises an aromatic C₆₋₁₀ aryl group.

6. A hyper-branched polymer according to claim 4, wherein the hydrophobic region in each branch comprises a polystyrene or a modified polystyrene.

7. A hyper-branched polymer according to claim 4, wherein the antimicrobially and/or anti-adhesively active region is comprised of polymer units of at least 20 monomers arranged in a block, wherein the monomers incorporate a group having an alkylated positively charged heteroatom.

8. A hyper-branched polymer according to claim 7, wherein said group having an alkylated positively charged heteroatom is selected from the group consisting of quaternary ammonium ions, quaternary pyridinium ions, quaternary phosphonium ions and ternary sulfonium ions.

9. A hyper-branched polymer according to claim 4, wherein the antimicrobially and/or anti-adhesively active region and the hydrophobic region are each comprised of monomers, the ratio between the number of monomers in the antimicrobially and/or anti-adhesively active region to the number of monomers in the hydrophobic region is between 2:1 and 100:1, and the polymer comprises 3 to 10,000 branches.

10. A hyper-branched polymer according to claim 1, wherein the hydrophobic core of the hyper-branched polymer possesses a branching degree of 0.4 to 0.8.

11. A hyper-branched polymer according to claim 1 in combination with at least one non-covalently bonded active substance selected from the group consisting of biocides, dyes and fragrances.

12. A hyper-branched polymer according to claim 1 wherein the hydrophobic core is comprised of a hyper-branched core, onto which a plurality of linear branches is linked, each linear branch comprising a block copolymer unit.

13. A hyper-branched polymer according to claim 1 wherein the hydrophobic core is a hyper-branched core comprised of diisopropenylbenzene units, onto which a plurality of linear branches is linked, each linear branch comprising a styrene block and a quaternized 4-vinylpyridine block.

14. A composition selected from the group consisting of cleaning compositions, hair treatment compositions and dental care compositions, comprising one or more hyper-branched polymers according to claim 1.

15. A process for providing semi-permanent antimicrobial and/or anti-adhesive properties to a surface, comprising treating the surface with a hyper-branched polymer according to claim 1.

16. A process for making a hyper-branched polymer in accordance with claim 1, said process comprising treating a hyper-branched core having a plurality of living centers with one or more monomers that carry quaternary ammonium groups, quaternary phosphonium groups or ternary sulfonium groups.

17. A process for making a hyper-branched polymer in accordance with claim 1, said process comprising:
a) treating a hyper-branched core having a plurality of living centers with one or more monomers that comprise at least one bonded heteroatom selected from nitrogen, phosphorus and sulfur to form a product; and
b) treating the product from a) with an alkylating agent in order to convert the bonded heteroatom into a quaternary or ternary heteroatom.

18. A process for making a hyper-branched polymer in accordance with claim 1, said process comprising:
a) treating a hyper-branched core having a plurality of living centers with one or more monomers that carry hydrophobic groups to obtain a product; and
b) treating the product from a) with one or more monomers that carry quaternary ammonium groups, quaternary phosphonium groups or ternary sulfonium groups.

19. A process for making a hyper-branched polymer in accordance with claim 1, said process comprising:
a) treating a hyper-branched core having a plurality of living centers with one or monomers that carry hydrophobic groups to form a first product;
b) treating the first product with one or more monomers that comprise organically bonded nitrogen, phosphorus or sulfur to form a second product; and
c) treating the second product with an alkylating agent in order to convert the organically bonded nitrogen, phosphorus or sulfur into a quaternary or ternary heteroatom.
